(19) United States
(12) Patent Application Publication
(10) Pub. No.: US 2004/0039906 A1
(43) Pub. Date: Feb. 26, 2004

(54) Access authorization management system, relay server, access authorization management method, and computer program

(76) Inventors: Makoto Oka, Tokyo (JP); Noboru Shimada, Tokyo (JP); Takayoshi Kawaguchi, Tokyo (JP); Madoka Masugi, Kanagawa (JP); Yoshihito Ishibashi, Tokyo (JP); Hiroshi Abe, Tokyo (JP); Nobutaka Toyoshima, Tokyo (JP)

Correspondence Address: FROMMER LAWRENCE & HAUG LLP, 745 FIFTH AVENUE, NEW YORK, NY, 10151, US

(21) Appl. No.: 10/456,191

(22) Filed: Jun. 5, 2003

(30) Foreign Application Priority Data
Jun. 7, 2002 (JP) 2002-167516

(51) Int. Cl. H04L 9/00

(52) U.S. Cl. 713/156

(57) ABSTRACT

A system and method for performing reliable access limitation in communication via a network are realized. In communication among communication processing devices via a communication network, a relay server such as a home server verifies and examines an attribute certificate of the access source, and determines whether or not the access source is a permitted member of the access destination. Only when the access source is permitted by the access destination, a name resolution process is performed, and the address information of the access destination is notified to the access source. A group attribute certificate in which the domain name and the host name of the access source are described is used, and the address corresponding to the domain name and the host name is updated.

### BACKGROUND OF THE INVENTION

1. Field of the Invention

The present invention relates to an access authorization management system, a relay server, an access authorization management method, and a computer program. For example, the present invention relates to an access authorization management system for providing a specific communication terminal or user with access authorization so as to allow access only from a device and/or a user having access authorization, to a relay server, to an access authorization management method, and to a computer program therefor.

2. Description of the Related Art

In recent years, communication via communication networks such as the Internet has become widespread. For devices connected to a network, mutual communication becomes possible by specifying the address of the communication destination. In the Internet, IP (Internet Protocol) is used as the routing protocol. The IP which is currently used is mainly IPv4, and an address (IP address) composed of 32 bits is used as the transmission source/destination. In Internet communication, global IP addressing which uniquely assigns a 32-bit IP address to each transmission source/destination is adopted, and individual transmission sources/destinations are identified.

The IP address (IPv4) is shown in such a manner that a 32-bit address is represented in decimal notation with 8-bit units. A sequence of such numerals is difficult for a user to memorize. For this reason, DNS (Domain Name System) for enabling communication by using a host name instead of the IP address is used.

A DNS server manages the correspondence between the IP addresses and the host names of terminals (hosts), so that, when communication is to be performed by a terminal, it is possible to access the DNS server and to obtain the host address (IP address) on the basis of the host name.

That is, since addresses are merely bit sequences, it is difficult for the user to directly manage these addresses. Therefore, in the Internet, a name which is easy for a human being to understand is assigned, and DNS is introduced as a mechanism for converting the name into an address.

In the WWW, content distribution services, etc., a user often accesses a device called a “server” which is dedicated to provide services, whereas, in the case of instant messaging where users chat with each other, there are cases in which the form in which devices of users are directly connected to each other is taken. This direct connection form is generally called “peer to peer”.

A peer-to-peer (P2P) network, which allows a direct communication among information processing devices, is a communication network in which, rather than disposing a server which performs processing intensively, information processing devices as resources possessed by each network client, for example, PCs, portable terminals, PDAs, cellular phones, and communication devices having a function of capable of a communication process, are directly connected.

It is said that the peer-to-peer (P2P) network technology was first used in APPN (Advanced Peer-to-Peer Networking) proposed by IBM Corp. of the United States. The use of such a network obviates the need to provide a huge distribution server which is required to perform content distribution in a conventional client-server network, making it possible for many users to use content which is distributed among resources possessed by each network client. It is thus possible to distributively store and deliver large-capacity content.

However, in the case of content distribution by a specific service provider, generally, a service provider performing distribution and a user build a trust relationship in advance by means of a contract, etc., and the data transmission side and the data reception side are capable of data transmission and reception on the basis of the trust relationship based on the contract. In contrast, in remote control and instant messaging, requests for accessing a communication terminal of each client occur from a large number of members of the general public having no particular trust relationship, and data transmission and reception are performed.

Therefore, for a client terminal as a communication processing device connected to the Internet, etc., there is a possibility that communication interference such as a DoS (Denial of Service) attack, etc., on the client terminal and a home network to which the client terminal is connected is received from another malicious network-connected device. The DoS attack makes it difficult to provide services by transmitting a large amount of data or commands.

Even between communication terminals in which a trust relationship is formed once, when that trust relationship is cancelled, if the address is a fixed address, it is possible to continue to perform access, presenting a problem in that invalid access and attacks may still be possible.

### SUMMARY OF THE INVENTION

The present invention has been made in view of the above-described problems, and provides a configuration which eliminates invalid accesses to a communication processing device, such as a client terminal connected to a network.

An object of the present invention is to provide an access authorization management system which realizes a configuration which permits an access request only from a user or a terminal permitted by a communication processing device functioning as a client terminal, such as a PC, a portable terminal, a PDA, or a cellular phone, and to provide a relay server, an access authorization management method, and a computer program therefor.

More specifically, the present invention takes into consideration countermeasures against a DoS attack, etc., in order to realize a secure home network. Another object of the present invention is to provide an access authorization management system which permits a request only from a user or a terminal for which access is permitted, and to provide a relay server, an access authorization management method, and a computer program therefor. This is achieved in a configuration where an access authorization confirmation process is performed in which an attribute certificate presented by an access requesting source is used and in which a name resolution process is performed on condition that the access authorization is confirmed in, for example, a home server connected to a network.

To achieve the above-mentioned objects, in one aspect, the present invention provides an access authorization management system in communication among communication processing devices via a communication network, the access authorization management system comprising: a name resolution server, having correspondence data between host names and addresses of access-destination communication processing devices, for performing a name resolution process concerning a host name corresponding to an access-destination communication processing device; and a relay server which receives the host name of the access-destination communication processing device from an access-source communication processing device, which receives a group attribute certificate storing group identification information which is set so as to correspond to a group formed of a set of specific communication processing devices and having an issuer electronic signature, which performs a process of verifying the group attribute certificate and a process of examining whether or not the access-source communication processing device belongs to the access permission group of the access-destination communication processing device, which obtains the address of the access-destination communication processing device by a name resolution process using the name resolution server on condition that the verification and examination are approved, and which notifies the address to the access-source communication processing device.

In one form of the access authorization management system of the present invention, the group attribute certificate may store a domain name as group identification information, and the relay server may perform a process of examining whether or not the access-source communication processing device belongs to the access permission group of the access-destination communication processing device by referring to a permission group database storing access permission group information by domain names as the access permission group information for the access-destination communication processing device.

In one form of the access authorization management system of the present invention, the group attribute certificate may store a host name as group identification information, and the relay server may perform a process of examining whether or not the access-source communication processing device belongs to the access permission group of the access-destination communication processing device by referring to a permission group database which stores access permission group information using host names as the access permission group information for the access-destination communication processing device.

In one form of the access authorization management system of the present invention, the relay server may be a home server connected via a network to the access-destination communication processing device.

In one form of the access authorization management system of the present invention, the relay server may have a configuration for performing an updating process for the address corresponding to the domain name or the host name corresponding to the access-destination communication processing device, and may perform the updating process on condition that the verification of an attribute certificate possessed by the access-destination communication processing device is approved.

In one form of the access authorization management system of the present invention, the relay server may perform mutual authentication with the access-source communication processing device and may perform the verification and examination of the group attribute certificate presented from the access-source communication processing device on condition that the mutual authentication is approved.

In one form of the access authorization management system of the present invention, the group attribute certificate may store link information on a public key certificate corresponding to the group attribute certificate, and the relay server may also perform verification of the public key certificate obtained by the link information when verifying the group attribute certificate.

In another aspect, the present invention provides a relay server for performing access authorization management in communication among communication processing devices via a communication network, wherein the relay server receives a host name of an access-destination communication processing device from an access-source communication processing device, receives a group attribute certificate storing group identification information which is set so as to correspond to a group formed of a set of specific communication processing devices and having an issuer electronic signature, performs a process of verifying the group attribute certificate and a process of examining whether or not the access-source communication processing device belongs to the access permission group of the access-destination communication processing device, obtains the address of the access-destination communication processing device by the name resolution process using a name resolution server on condition that the verification and examination are approved, and notifies the address to the access-source communication processing device.

In one form of the relay server of the present invention, the group attribute certificate may store a domain name as group identification information, and the relay server may perform a process of examining whether or not the access-source communication processing device belongs to the access permission group of the access-destination communication processing device by referring to the permission group database in which access permission group information using domain names is stored as the access permission group information for the access-destination communication processing device.

In one form of the relay server of the present invention, the group attribute certificate may store a host name as group identification information, and the relay server may perform a process of examining whether or not the access-source communication processing device belongs to the access permission group of the access-destination communication processing device by referring to a permission group database in which access permission group information using host names is stored as the access permission group information for the access-destination communication processing device.

In one form of the relay server of the present invention, the relay server may be a home server connected via a network to the access-destination communication processing device.

In one form of the relay server of the present invention, the relay server may have a configuration for performing a process for updating an address corresponding to the domain name or the host name corresponding to the access-destination communication processing device, and may perform an updating process on condition that the verification of an attribute certificate possessed by the access-destination communication processing device is approved.

In one form of the relay server of the present invention, the relay server may perform mutual authentication with the access-source communication processing device, and may perform the verification and examination of a group attribute certificate presented from the access-source communication processing device.

In one form of the relay server of the present invention, the group attribute certificate may store link information on a public key certificate corresponding to the group attribute certificate, and the relay server may also perform the verification of the public key certificate obtained by the link information when verifying the group attribute certificate.

In another aspect, the present invention provides an access authorization management method in communication among communication processing devices via a communication network, the access authorization management method comprising the steps of: receiving, in a relay server, the host name of an access-destination communication processing device from an access-source communication processing device, and receiving a group attribute certificate storing group identification information which is set so as to correspond to a group formed of a set of specific communication processing devices and having an issuer electronic signature; performing a process of verifying the group attribute certificate and a process of examining whether or not the access-source communication processing device belongs to the access permission group of the access-destination communication processing device; and obtaining the address of the access-destination communication processing device by a name resolution process using a name resolution server on condition that the verification and examination are approved and notifying the address to the access-source communication processing device.

In one form of the access authorization management system of the present invention, the group attribute certificate may store a domain name as group identification information, and the relay server may perform a process of examining whether or not the access-source communication processing device belongs to the access permission group of the access-destination communication processing device by referring to a permission group database in which access permission group information using domain names is stored as the access permission group information for the access-destination communication processing device.

In one form of the access authorization management system of the present invention, the group attribute certificate may store a host name as group identification information, and the relay server may perform a process of examining whether or not the access-source communication processing device belongs to the access permission group of the access-destination communication processing device by referring to a permission group database in which access permission group information using host names is stored as the access permission group information for the access-destination communication processing device.

In one form of the access authorization management system of the present invention, the relay server may be a home server connected via a network to the access-destination communication processing device.

In one form of the access authorization management system of the present invention, the access authorization management method may further comprise a step in which the relay server performs a process of updating the address corresponding to the domain name or the host name corresponding to the access-destination communication processing device, wherein the updating process is performed on condition that the verification of the attribute certificate possessed by the access-destination communication processing device is approved.

In one form of the access authorization management system of the present invention, the relay server may perform mutual authentication with the access-source communication processing device, and may perform the verification and examination of the group attribute certificate presented from the access-source communication processing device on condition that the mutual authentication is approved.

In one form of the access authorization management system of the present invention, the group attribute certificate may store link information on the public key certificate corresponding to the group attribute certificate, and the relay server may also perform the verification of the public key certificate obtained by the link information when verifying the group attribute certificate.

In another aspect, the present invention provides a computer program for executing an access authorization management process in communication among communication processing devices via a communication network, the computer program comprising the steps of: receiving the host name of an access-destination communication processing device from an access-source communication processing device, and receiving a group attribute certificate storing group identification information which is set so as to correspond to a group formed of a set of specific communication processing devices and having an issuer electronic signature; performing a process of verifying the group attribute certificate and a process of examining whether or not the access-source communication processing device belongs to the access permission group of the access-destination communication processing device; and obtaining the address of the access-destination communication processing device by a name resolution process using a name resolution server on condition that the verification and examination are approved, and notifying the address to the access-source communication processing device.

According to the configuration of the present invention, in communication among communication processing devices via a communication network, a relay server such as a home server determines whether or not an access source is permitted by an access destination. Only when the access source is permitted by the access destination, a name resolution process is performed, and the address information of the access destination is notified to the access source. Therefore, only access from the access source permitted by the access destination can be performed.

According to the configuration of the present invention, in communication among communication processing devices via a communication network, a relay server such as a home server verifies and examines an attribute certificate of the access source, and determines whether or not the access source is a permitted member of the access destination. Only when the access source is permitted by the access destination, a name resolution process is performed, and the address information of the access destination is notified to the access source. Therefore, access can reliably be limited based on the examination in accordance with the attribute certificate.

According to the configuration of the present invention, a group attribute certificate is used in which the domain name and the host name are described as attribute information, such as the domain name attribute certificate and the host name attribute certificate of the access source. Therefore, access limited to a device belonging to a specific domain or a specific host name can be performed.

According to the configuration of the present invention, a group attribute certificate, such as the domain name attribute certificate and the host name attribute certificate of the access source, is used in which the domain name and the host name are described as attribute information, and the address corresponding to the domain name and the host name is updated. Therefore, it is possible to eliminate access using an old address.

The computer program of the present invention is a computer program which can be provided to, for example, a computer system capable of executing various program codes by a recording medium or a communication medium in a computer-readable form, for example, a recording medium such as a CD, an FD, or an MO, or a communication medium such as a network. By providing such a program in a computer-readable form, processes corresponding to the program are executed on the computer system.

Further objects, features and advantages of the present invention will become apparent from the following detailed description of the embodiments of the present invention with reference to the attached drawings. In this specification, the system is a logical group of a plurality of devices. It is not essential that the devices be disposed in the same housing.

### BRIEF DESCRIPTION OF THE DRAWINGS

FIG. 1 illustrates the configuration of public key infrastructure and authorization management infrastructure in an access authorization management system;

FIG. 2 shows the format of a public key certificate;

FIG. 3 shows the format of a public key certificate;

FIG. 4 shows the format of a public key certificate;

FIG. 5 shows the format of an attribute certificate as an authorization information certificate;

FIGS. 6A, 6B, 6C, 6D, 6E, and 6F show an example of the structure of a group attribute certificate (group AC);

FIGS. 7A and 7B show the format of a domain name attribute certificate and a host name attribute certificate;

FIG. 8 illustrates a domain-name attribute-certificate issuing system;

FIG. 9 illustrates a host-name attribute-certificate issuing system;

FIG. 10 shows a trust model illustrating the trust relationship between entities participating in the access authorization management system;

FIG. 11 shows an example of the configuration of a security chip formed in an entity, such as a user device, a home server, a service provider, etc.;

FIG. 12 shows an example of stored data of a security chip of a user device;

FIG. 13 illustrates an overview of the access authorization management system;

FIGS. 14A and 14B show an example of the structure of a database possessed by a name resolution server;

FIG. 15 shows a domain name registration process sequence;

FIG. 16 shows a domain name attribute certificate issuing process sequence;

FIG. 17 shows a hand-shake protocol (TLS (Transparent LAN Service) 1.0), which is one authentication processing method of public key cryptosystem;

FIG. 18 shows the generation structure of a message authentication code (MAC);

FIG. 19 is a flowchart illustrating an electronic signature generation process;

FIG. 20 is a flowchart illustrating an electronic signature verification process;

FIG. 21 shows a new-end-entity (EE) registration process sequence;

FIG. 22 shows a domain-name attribute-certificate issuing process sequence by an end entity (EE);

FIG. 23 shows a host-name attribute-certificate issuing process sequence by an end entity (EE);

FIG. 24 shows an access-permission-group information registration process sequence by an end entity (EE);

FIG. 25 shows an example of the data structure of the access permission group information;

FIG. 26 shows an access-permission-group information deletion process sequence by an end entity (EE);

FIG. 27 illustrates an access process sequence involving the confirmation of access authorization;

FIG. 28 illustrates an address obtaining process sequence based on a domain name;

FIG. 29 illustrates the relationship between a public key certificate (PKC) and an attribute certificate (AC);

FIG. 30 is a flowchart showing an attribute certificate (AC) verification process;

FIG. 31 is a flowchart showing a public key certificate (PKC) verification process;

FIG. 32 is a sequence diagram illustrating an access authorization examination process;

FIG. 33 illustrates an access process sequence involving the confirmation of access authorization;

FIG. 34 shows a process sequence for updating the address of an end entity (EE);

FIG. 35 shows a process sequence for updating the address space of an end entity (EE);

FIG. 36 shows a process sequence for updating the address space corresponding to a domain;

FIG. 37 shows a process sequence for updating the address corresponding to a domain;

FIG. 38 illustrates advantages by the address updating process; and

FIG. 39 shows an example of the configuration of an information processing device of each entity, such as a user device, a home server, a service provider, etc.

### DESCRIPTION OF THE PREFERRED EMBODIMENTS

The present invention will now be described below in detail with reference to the drawings. The description is given in the sequence described below:

(1) Access Authorization Management System Configuration Overview

(2) User Device Configuration

(3) Access Limitation Process

(3-1) Access Limitation Process Overview

(3-2) Domain Registration Process and Attribute Certificate Issuing Process

(3-3) Access Permission Information Registration and Deletion Processes

(3-4) Access Permission Determination Process

(3-5) Address Updating Process

(4) Configuration of Each Entity

[(1) Access Authorization Management System Overview]

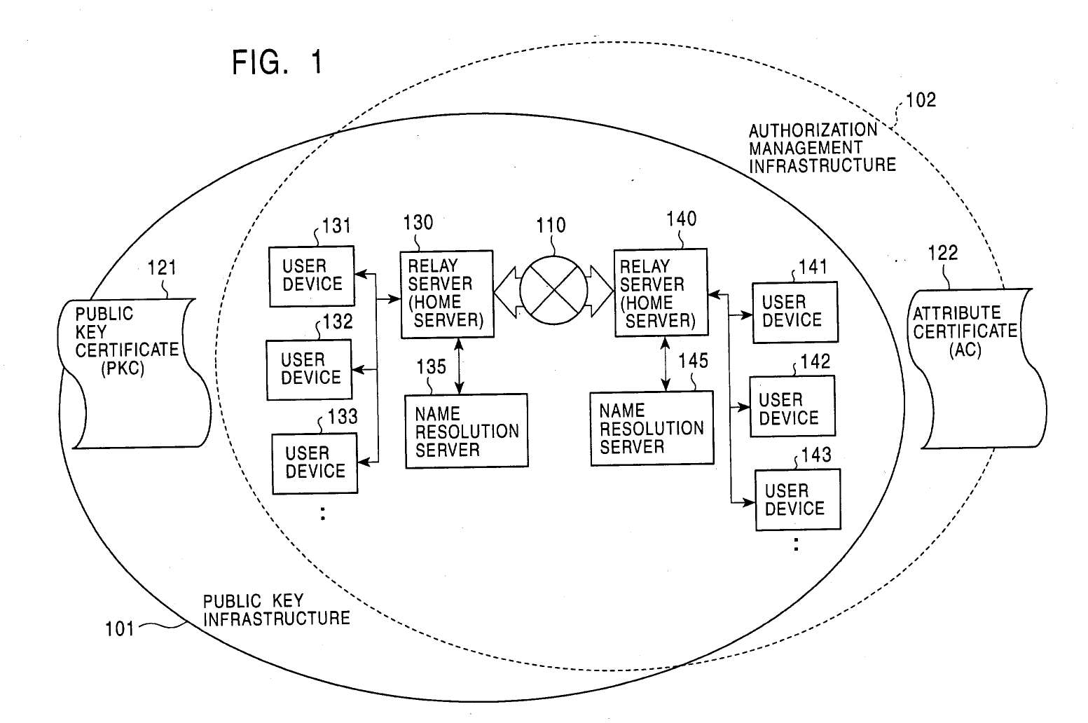

As shown in FIG. 1, the access authorization management system of the present invention has, as basic infrastructures, a public key infrastructure (PKI) 101, based on a public key certificate (PKC) 121, and a privilege management infrastructure (PMI) 102, based on an attribute certificate (AC) 122. Under these infrastructures, user devices 131 to 133 as communication processing devices and user devices 141 to 143, having a tamper-resistant security chip (or a security module), perform communication via a network.

The user devices 131 to 133 perform communication via a relay server 130, such as a home server, over a network 110, and the user devices 141 to 143 perform communication via a relay server 140 over the network 110.

The user devices 131 to 133 and the relay server 130, such as the home server, form a sub-network and are connected by a wired or wireless LAN, such as Ethernet or another communication network. The relay server 130 performs a process of determining access authorization concerning an access request for the user devices 131 to 133 within a management area of the relay server 130 on the basis of an attribute certificate 122, such as a group attribute certificate (to be described below in detail), performs a process of converting a host name to an address by a name resolution server 135 as DNS (Domain Name System) with respect to only the access request which is determined to have access authorization, and notifies the address data of the access destination, obtained by name resolution, to the access requesting source. Also, in a similar manner, the relay server 140 determines the access authorization of the access request for the user devices 141 to 143 within the management area of the relay server 140 on the basis of the attribute certificate 122, such as a group attribute certificate, and performs similar processes.

The user devices 131 to 133 and 141 to 143 are terminals capable of performing communication processes among user devices via the network 110. More specifically, they are formed of PCs, game terminals, DVD or CD playback devices, portable communication terminals, PDAs, memory cards, etc., and incorporate tamper-resistant security chips. The details of the user devices will be described later.

FIG. 1 shows the communication control configuration among user devices. Also, when a user device receives from a service provider, various services, such as provision of services of various types of content, such as music, video, and programs, other information using services, and settlement services, it is possible to determine the access authorization similarly using the attribute certificate and to execute a name resolution process based on the determination. The access authorization management system of the present invention can be applied to not only access control among user devices, but also to access control among various entities, for example, among the service provider and user devices.

Public Key Certificate: PKC

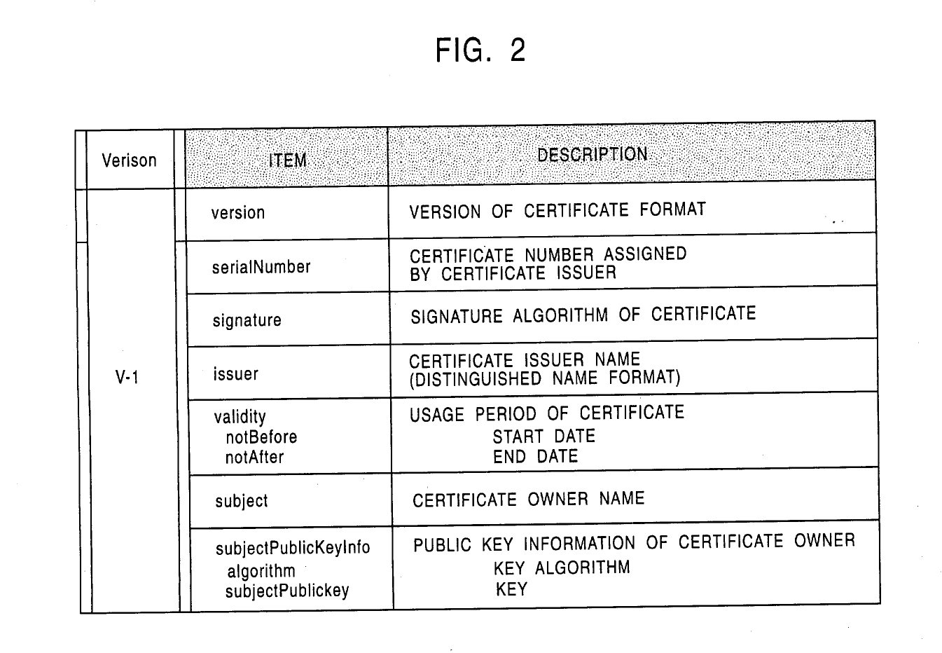

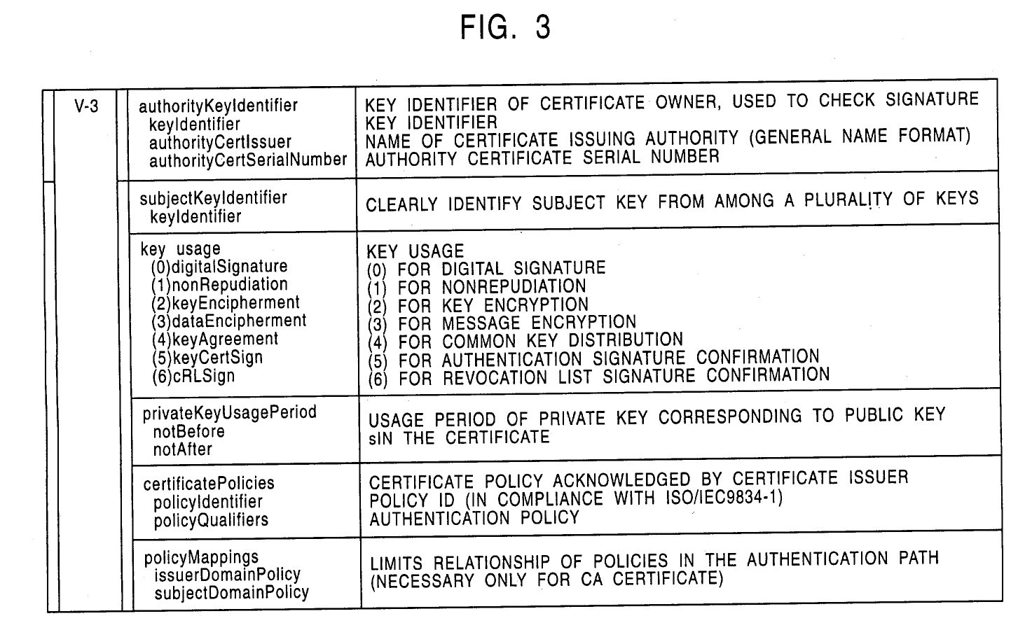

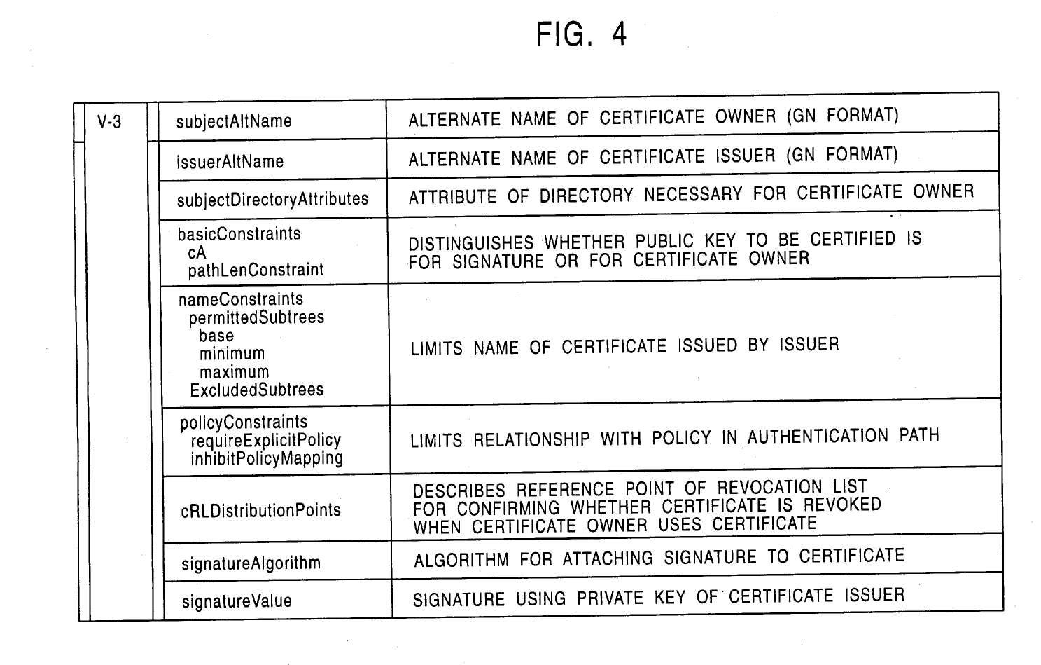

A public key certificate will now be described. The public key infrastructure (PKI) 101 is infrastructure in which the public key certificate (PKC) is used to allow the execution of an authentication process among communication entities, a process for encrypting data to be transferred, etc. The public key certificate (PKC) is described with reference to FIGS. 2, 3, and 4. The public key certificate is a certificate issued by a certification authority (CA), and is formed in such a manner that, when a user and each entity present their ID, public key, etc., to the certification authority, the certification authority adds information, such as the ID of the certification authority, an expiration date, etc. thereto, and adds a signature thereto.

A common practice is for a registration authority (RA) to be established as an administrative organization for the certification authority (CA), and, in the registration authority, applications for issuing public key certificates (PKC) are accepted and the applicants are examined and managed.

Examples of the format of the public key certificate are shown in FIGS. 2 to 4. These are examples conforming with the public key certificate format ITU-T X.509.

Version indicates the version of the certificate format, and serial number is the serial number of the public key certificate, which is set by the public key certificate issuing authority (IA).

Signature is the signature algorithm of the certificate. Examples of the signature algorithm include elliptic curve encryption and RSA. When elliptic curve encryption is used, the parameters and the key length are recorded, and when RSA is used, the key length is recorded.

Issuer is a field in which the issuer of the public key certificate, that is, the name of the public key certificate issuing authority (IA), is recorded as a distinguished name.

In usage period (validity), the start date and the end date, which indicate the usage period of the certificate, are recorded.

In subject public key information, the key algorithm and the key are stored as the public key information of the certificate owner.

Authority key identifier (key identifier, authority certificate issuer, authority certificate serial number) is information for identifying the key of the certified issuer, which is used for signature verification, and the key identifier, the organization name of the certificate issuer, and the organization certificate serial number are stored.

Subject key identifier stores an identifier for identifying each key when a plurality of keys are certified in the public key certificate.

Key usage is a field for specifying the purpose of the key, wherein the usage may be set to (0) for a digital signature, (1) for nonrepudiation, (3) for message encryption, (4) for distributing a common key, (5) for confirming authentication signature, and (6) for confirming signature of revocation list.

In private key usage period, the expiration date of the usage period corresponding to the public key stored in the certificate is recorded.

In certificate policies, the certificate issuing policies of the public key certificate issuer, for example, a policy ID in conformance with ISO/IEC 9384-1 and an authentication reference, are recorded.

Policy mapping is a field for storing information on policy-related limitations in the authentication path, and is necessary only for the certification authority (CA) certificate.

Subject alternate name is a field for recording an alternate name of the certificate owner.

Issuer alternate name is a field for recording an alternate name of the certificate issuer.

Subject directory attribute is a field for recording the attribute of a directory required for the certificate owner.

Basic constraint is a field for distinguishing whether the public key to be authenticated is for the signature of the certification authority (CA) or for the certificate owner.

Name constraint permitted subtrees is a field for storing the limitation information of the name of the certificate issued by the issuer.

Policy constraints is a field for storing the policy-related information in the authentication path.

CRL reference point (certificate revocation list distribution point) is a field for describing a reference point of a revocation list for confirming whether or not the certificate should be revoked when the certificate owner uses the certificate.

Signature algorithm is a field for storing an algorithm used to attach a signature.

Signature is a signature field of the public key certificate issuer. An electronic signature is data generated by generating a hashed value by using a hash function on the entire certificate and by using the private key of the owner on that hashed value. Only attaching a signature and calculating a hash cannot eliminate falsification, but detection has substantially the same effect as that falsification cannot be performed.

The certification authority issues the public key certificate shown in FIGS. 2 to 4, updates a public key certificate whose expiration date has expired, and creates, manages, and distributes the revocation list for eliminating users who have done something illegal (this is called a “revocation”). Furthermore, the public key and the private key are generated as necessary.

On the other hand, when this public key certificate is used, the user verifies the electronic signature of that public key certificate by using the public key of the certification authority, which is possessed by the user, extracts the public key from the public key certificate after the verification of the electronic signature is successful, and uses that public key. Therefore, all the users who use public key certificates need to hold the common public key of the certification authority.

Attribute Certificate (AC)

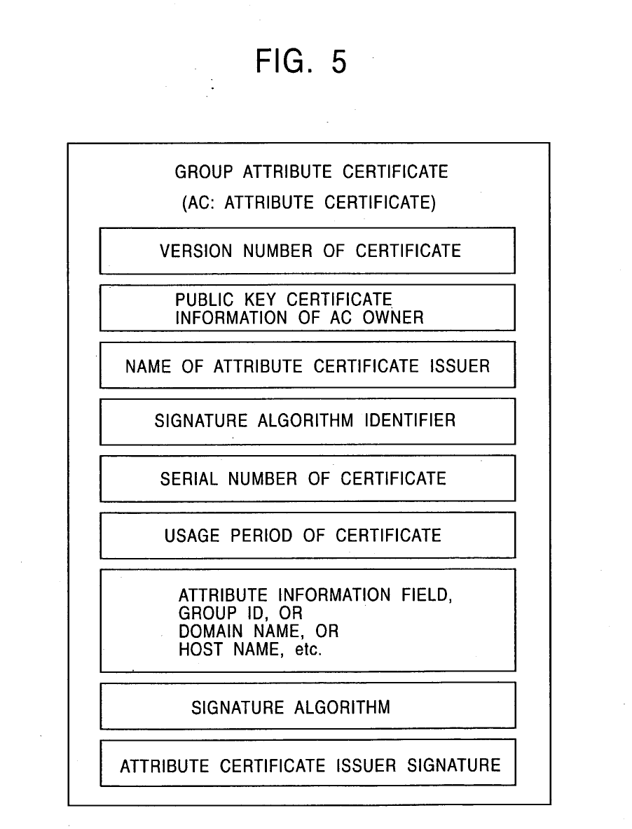

The privilege management infrastructure (PMI) 102 is infrastructure for enabling a privilege confirmation process using an attribute certificate (AC) 122. A group attribute certificate (group AC), as one form of the attribute certificate, will now be described with reference to FIGS. 5 to 7. The function of the attribute certificate used in the system of the present invention is to confirm access authorization and service use privilege, and in the attribute certificate, for example, the attribute information of the owner, which can be used as access permission information for a user device (end entity) as a specific communication processing device, is described.

The attribute certificate is basically a certificate issued by the attribute certification authority/attribute certificate issuing authority (AA: Attribute Authority). The attribute certificate is created in such a manner that attribute information for a certificate to be issued is stored, information such as the ID and the expiration date is added by the attribute certification authority/attribute certificate issuing authority, and a signature by the private key of the attribute certification authority/attribute certificate issuing authority is added. However, the group attribute certificate to be described below is not always limited to that the attribute certification authority/attribute certificate issuing authority is the issuing organization, and the group attribute certificate can be issued in the service provider, the relay server such as a home server, and the user device.

The processing load can be distributed by a configuration in which an attribute certificate registration authority (ARA) is provided as an administrative organization for the attribute certification authority/attribute certificate issuing authority (AA), and in which, in the attribute certificate registration authority (ARA), applications for issuing attribute certificates (AC) are accepted, and applicants are examined and managed.

The group attribute certificate (group AC) used in the configuration of the present invention is an attribute certificate which is issued to a device or user forming a group, in which a plurality of targets, for example, a plurality of users or a plurality of user devices, are set as a group having one and the same attribute set, and the set group is assumed to be a unit. The group attribute certificate is a certificate in which group identification information, which is set so as to correspond to a group formed of a set of specific devices or specific users, is stored information, and the electronic signature of the issuer is added.

The group attribute certificate is issued to each user or each user device belonging to, for example, a group of attributes such as a firm, an organization, and a school to which a plurality of persons belong, or a group called a family. Alternatively, the group attribute certificate is issued to a member (user, user device) of a group of a plurality of user units which receive services provided by one service provider. Furthermore, a group definition by, for example, a domain name or a host name, can be used. For the group, various settings are possible, and specific examples will be described later.

The basic format of the attribute certificate is defined by ITU-T X.509, and a profile is formulated according to IETF PKIX WG. Unlike the public key certificate, the attribute certificate does not contain the public key of the owner. However, the attribute certificate is similar to the public key certificate in that, since the signature of the attribute certification authority is attached, the determination of whether or not falsification has occurred can be carried out by verifying this signature.

The group attribute certificate used in the present invention can be formed so as to be compliant with the basic format of the attribute certificate. However, it is not necessary to strictly follow the format defined by the ITU-T X.509; an attribute certificate having a unique format may be formed.

In the configuration of the present invention, the functions of the attribute certificate authority (AA), which performs issuing management of attribute certificates (AC), and the attribute certificate registration authority (ARA) can also be served by the service provider, the home server, and the user device. That is, a configuration is possible in which the service provider, the home server, or the user device itself carries out each function of the attribute certificate authority (AA) and the attribute certificate registration authority (ARA).

The attribute certificate is basically used in such a manner as to be associated with the public key certificate. That is, the identity of the attribute certificate owner is confirmed by the public key certificate, and after that, what kinds of privileges are provided to the owner is confirmed by the attribute certificate. For example, whether or not a specific user device (end entity) has access authorization is confirmed by verifying the attribute certificate of the access requesting source using the home server, which functions as the relay server that manages that user device (end entity). When verifying an attribute certificate, after the signature verification of that certificate is performed, the verification of the public key certificate associated with that attribute certificate is also performed.

In that case, it is preferable that, in principle, the certificate chain be traced back to verify up to the highest-order public key certificate in sequence. In a configuration in which a plurality of certification authorities (CA) exist and a hierarchical structure is formed, the public key certificate of a lower-order certification authority is itself signed by a higher-order certification authority which issues that public key certificate. That is, a chain-like public key certificate issuing configuration is taken in which a higher-order public key certificate issuing authority (CA-high) issues a public key certificate to a lower-order public key certificate issuing authority (CA-low). Chain verification of the public key certificate means that the certificate chain is traced back from the low order to the high order in order to obtain the chain information up to the highest-order public key certificate and the signature verification of the public key certificate up to the highest order (root CA) is performed.

By making the expiration period of the attribute certificate short, it is not necessary to perform a revocation process. In this case, the certificate revocation procedure, the revocation information referring procedure, etc., can be skipped, thus presenting the advantages in that the system is simplified. However, since some kinds of countermeasures other than revocation are required against the illegal use of the certificate, sufficient care must be paid.

The organization of the group attribute certificate will now be described with reference to FIG. 5.

Version number of the certificate indicates the version of the certificate format.

Public key certificate information of the AC owner is information on the public key certificate (PKC) corresponding to the issuer of the attribute certificate (AC), that is, information such as the name of the PKC issuer, the PKC serial number, the unique identifier of the PKC issuer, etc., and functions as chain data for associating the corresponding public key certificate.

Name of the issuer of the attribute certificate is a field in which the issuer of the attribute certificate, i.e., the name of the attribute certificate authority (AA), is recorded as a distinguished name.

Signature algorithm identifier is a field in which the signature algorithm identifier of the attribute certificate is recorded.

In the usage period of the certificate, the start date and the end date, which indicate the usage period of the certificate, are recorded.

In the attribute information field, attribute information which specifies a group, such as the group ID, the domain name, the host name, etc., is stored as the group identification information which identifies the group of the group attribute certificate.

In the attribute information field, various types of information, other than the group identification information (the group ID, the domain name, the host name, etc.), can be stored. For example, the access authorization period information and other detailed information on access authorization can be stored.

In the attribute certificate, the signature algorithm is further recorded, and a signature is attached by the issuer of the attribute certificate, for example, the attribute certificate authority (AA). When the issuer is a service provider, a home server, or a user device, the signature of each issuer is attached. The electronic signature is data which is generated by generating a hashed value by applying a hash function to the entire attribute certificate and by using the private key of the attribute certificate issuer on that hashed value.

The group attribute certificate is issued based on the issuing policy managed by the entity which issues the group attribute certificate, for example, the attribute certificate authority (AA), the attribute certificate registration authority (ARA) which handles the clerical work of the attribute certificate authority (AA) so as to act on behalf thereof, the service provider, the home server, and the user device.

The entity which issues the group attribute certificate has an issuing policy table, which contains data in which the group identification information (the group ID, the domain name, the host name, etc.) of the group attribute certificate issued by the entity itself, the group information, and the issuing policy, such as the issuing reference, correspond to one another. Furthermore, when a group attribute certificate is newly issued, is additionally issued, or is updated, examination is performed on the basis of the issuing policy table of the group attribute certificate, and a procedure such as issuing or updating is performed only when the policy is satisfied.

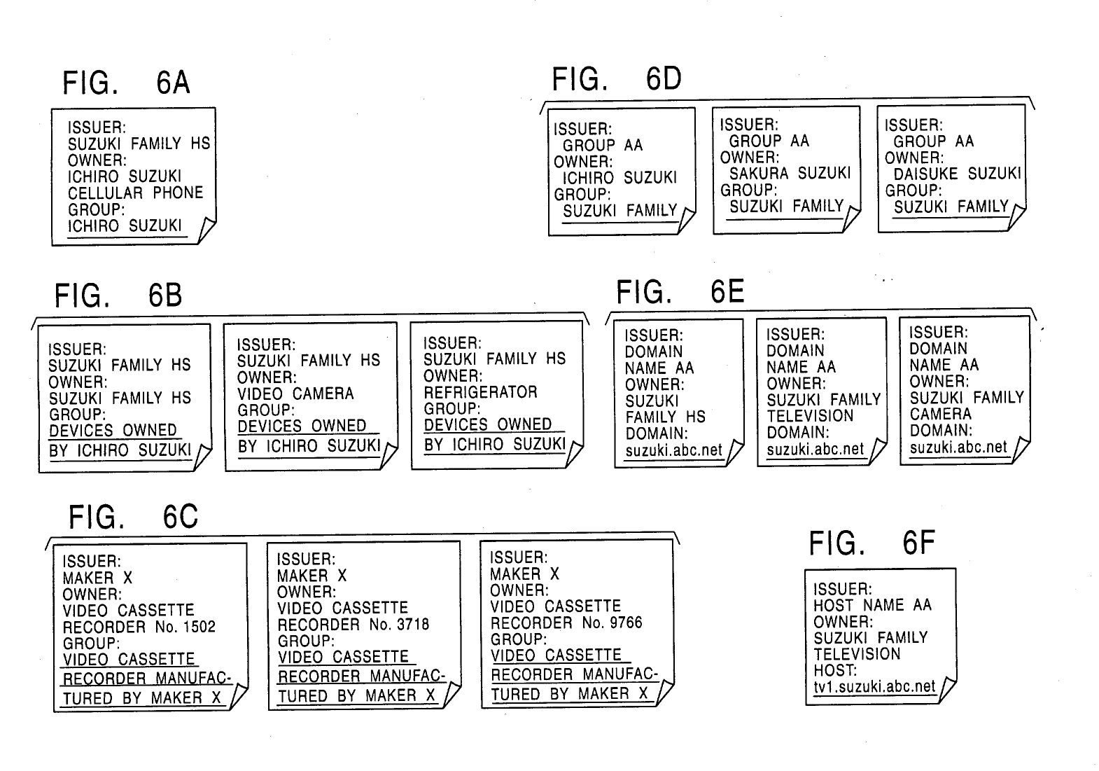

FIGS. 6A to 6F show an example of the structure of an issuer, an owner, a verifier, and the attribute information of the group attribute certificate (group AC).

(a) shows a group formed of a single device, and also shows the group attribute certificate (group AC) of the group which is defined as the issuer: Suzuki family home server (HS), the owner: the cellular phone of Ichiro SUZUKI, and the group: Ichiro SUZUKI. (b) shows a group formed of a plurality of devices, and also shows the group attribute certificate (group AC) of the group defined as the issuer: Suzuki family home server (HS), the owner: devices of the home server (HS), a video camera, and a refrigerator of Suzuki family, and the group: devices owned by Ichiro SUZUKI.

(c) shows a group formed of a plurality of devices, and also shows the group attribute certificate (group AC) of the group defined as the issuer: maker X, the owner: each device of a video cassette recorder, and the group: the video cassette recorder manufactured by the maker X. (d) shows a group formed of a plurality of users, and also shows the group attribute certificate (group AC) of the group defined as the issuer: the attribute certificate authority (AA), the owner: a member of Suzuki family, and the group: Suzuki family.

(e) shows the domain-name attribute certificate in which group definition by the domain name is made, and is the group attribute certificate (group AC) of the group defined as, for example, the issuer: the domain-name-group attribute certificate authority (AA), the owner: the Suzuki family HS, television, camera, and the group domain: suzuki.abc.net. The communication processing devices belonging to the same domain possess a domain-name-group attribute certificate having the same group domain as the attribute information.

(f) shows a host-name attribute certificate for which group definition by the host name is made, and also shows the group attribute certificate (group AC) of the group which is defined as, for example, the issuer: the host-name-group attribute certificate authority (AA), the owner: a Suzuki family television, and the group host name: tv1.suzuki.abc.net.

When the group attribute certificate is issued for the target of a device or a user belonging to a group of various definitions, the issued group attribute certificate is stored in the device owned by the user. The details of the user device will be described later.

The verifier which performs access authorization confirmation based on the group attribute certificate issued to the user device is, for example, a relay server, such as the home server, shown in FIG. 1. The relay server receives the group attribute certificate from a device which requests an access to the user device (communication processing device) in the management area of the relay server, performs the verification and examination of the received group attribute certificate, requests the name resolution server to perform a process of converting the host name into an address on condition that the access authorization is confirmed, and notifies the obtained address to the access requesting source, thus enabling communication using the received address. When the verification and examination of the attribute certificate show that the access authorization is not recognized, the conversion from the host name into the address is not performed by the name resolution server, the access requesting source cannot obtain the address of the access request destination, and the communication process is not performed.

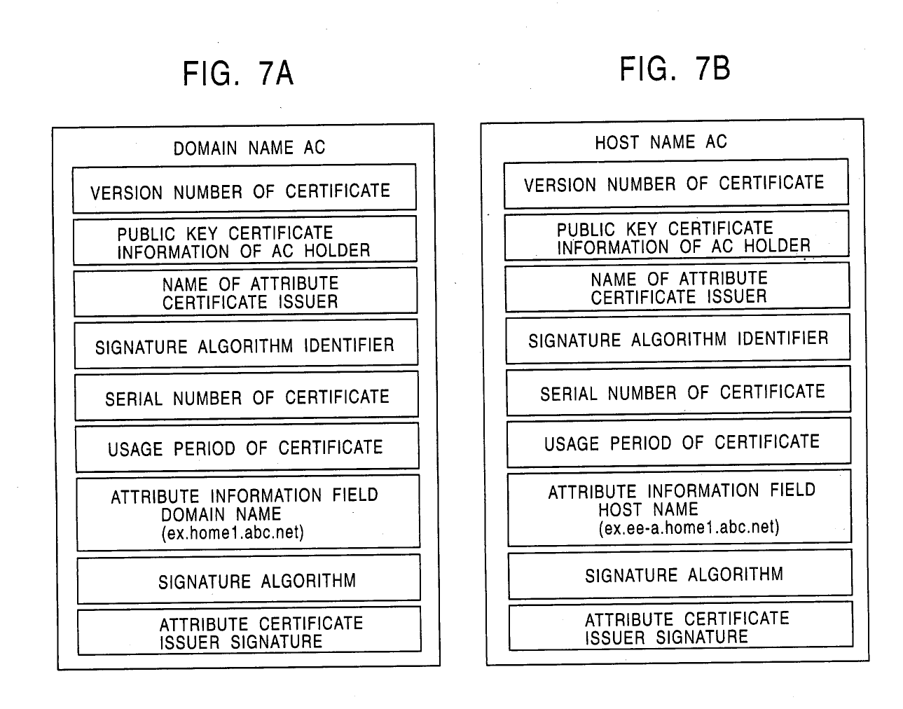

FIGS. 7A and 7B show an example of the structure of the attribute certificate based on each group definition of the domain name group (FIG. 6E) and the host name group (FIG. 6F) in the group attribute certificate based on various group definitions described with reference to FIGS. 6E and 6F. In the domain-name-group attribute certificate (FIG. 7A), the domain name is described in the attribute information field, and a specific domain is identified. On the other hand, in the host-name-group attribute certificate (FIG. 7B), the host name is described in the attribute information field, and a specific host can be identified.

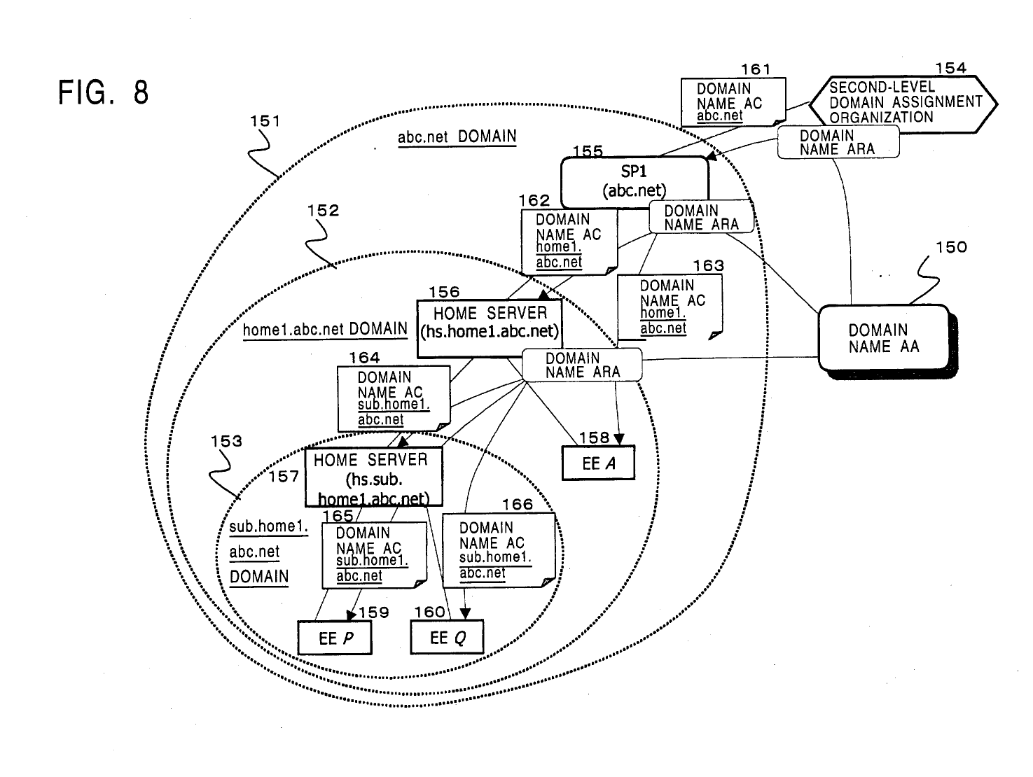

Referring to FIG. 8, the issuing system of the domain-name-group attribute certificate will now be described. The domain-name-group attribute certificate is, in principle, issued from the domain-name attribute certificate authority (AA) through the higher-order domain-name attribute-certificate registration authority (ARA) of the associated domain. The number of domain names AA is not limited to one, and a plurality of domain names may exist. Furthermore, the management organization is preferably an independent business organization by taking into consideration the public nature of the domains.

FIG. 8 shows three domain areas of an abc.net domain 151, a home1.abc.net domain 152, and a sub.home1.abc.net domain 153 as domains starting from the high order. The higher-order domain contains the lower-order domains.

For the domain-name-group attribute certificate for a service provider 155 of the abc.net domain 151, a second-level domain assignment organization 154, which is a higher-order domain-name attribute-certificate registration authority (ARA), performs the issuing procedure based on the issuing policy in accordance with the request from the service provider 155, and sends the domain-name-group attribute certificate 161 issued by the domain-name attribute certificate attribute certificate authority (AA) 150 on condition that the issuing is compliant with the policy.

For a domain-name-group attribute certificate for a home server 156 of the home1.abc.net domain 152, which is a lower-order domain of the abc.net domain 151, or for EE A158 which is an end entity (user device), the service provider 155, which is a higher-order domain-name attribute-certificate registration authority (ARA), performs an issuing procedure based on the issuing policy in accordance with a request from the home server 156 and the EE A158, and sends the domain-name-group attribute certificates 162 and 163, issued by the domain-name attribute certificate authority (AA) 150, to the home server 156 and the EE A158, respectively, on condition that the issuing is compliant with the policy.

For a domain-name-group attribute certificate for a home server 157 of the sub.home1.abc.net domain 153, which is a lower-order domain of the home1.abc.net domain 152 or for EE P159 and EE Q160, which are end entities (user devices), the home server 156, which is a higher-order domain-name attribute-certificate registration authority (ARA), performs an issuing procedure based on the issuing policy in accordance with requests from the home server 157, the EE P159, and the EE Q160, and sends the domain-name-group attribute certificates 164 to 166 to the home server 157, the EE P159, and the EE Q160, respectively, on condition that the issuing is compliant with the policy.

In the manner described above, the domain-name attribute-certificate registration authority (ARA) performs a process of issuing the domain-name-group attribute certificate to a member (device) belonging to a lower-order domain on the basis of the issuing policy.

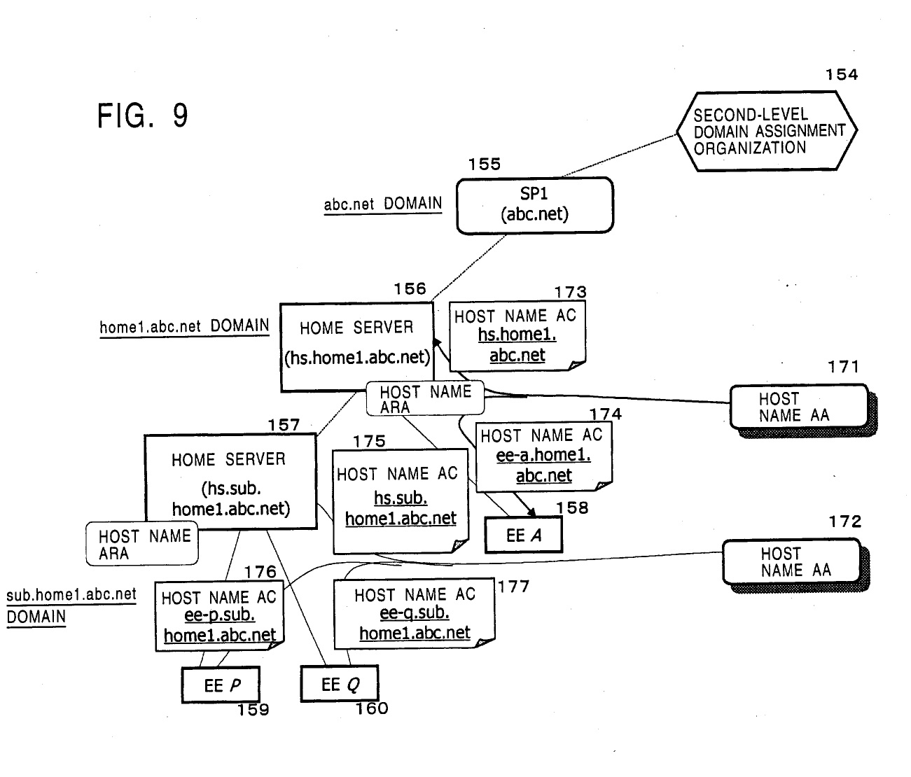

Referring to FIG. 9, the host-name-group attribute certificate issuing system will now be described below. The host-name-group attribute certificate is, in principle, issued from the domain-name attribute certificate authority (AA) through the host name attribute certificate registration authority (ARA) of the associated domain. The host names AA may be managed by a service provider.

Similarly to FIG. 8, FIG. 9 shows that entities belonging to the three corresponding domains, i.e., the abc.net domain, the home1.abc.net domain, and the sub.home1.abc.net domain as domains starting from the high order are described, the service provider 155 belongs to the abc.net domain, the home server 156 and the EE A158 which is an end entity (user device) belong to the home1.abc.net domain, and the home server 157 of the EE P159 and the EE Q160 belong to the sub.home1.abc.net domain.

For the host-name-group attribute certificate for the home server 156 of the home1.abc.net domain or for the EE A158 which is an end entity (user device), the home server 156, which is a host name attribute certificate registration authority (ARA) corresponding to the associated domain performs an issuing procedure based on the issuing policy, and sends the host-name-group attribute certificates 173 and 174, issued from the host name attribute certificate authority (AA) 171, to the home server 156 and the EE A158, respectively, on condition that the issuing is compliant with the policy.

For the host-name-group attribute certificate for the home server 157 of the sub.home1.abc.net domain 153 which is a lower-order domain of the home1.abc.net domain 152 or for the EE P159 and the EE Q160, which are end entities (user devices), the home server 157, which is a host name attribute certificate registration authority (ARA) corresponding to the associated domain, performs an issuing procedure based on the issuing policy, and sends the domain-name-group attribute certificates 175 to 177, issued from the host name attribute certificate authority (AA) 172, to the home server 157, the EE P159, and the EE Q160, respectively, on condition that the issuing is compliant with the policy.

In the manner described above, the domain-name attribute-certificate registration authority (ARA) within the corresponding domain performs a process for issuing the host-name-group attribute certificate to the member belonging to its own domain.

The issued attribute certificate is stored after the verification by the signature verification in the security module within the device of the service provider or in the relay server such as the home server, or in the security chip (SC) of the user device. It is preferable that the relay server such as the home server, the security chip of the user device, and the security module within the device of the service provider are tamper-resistant.

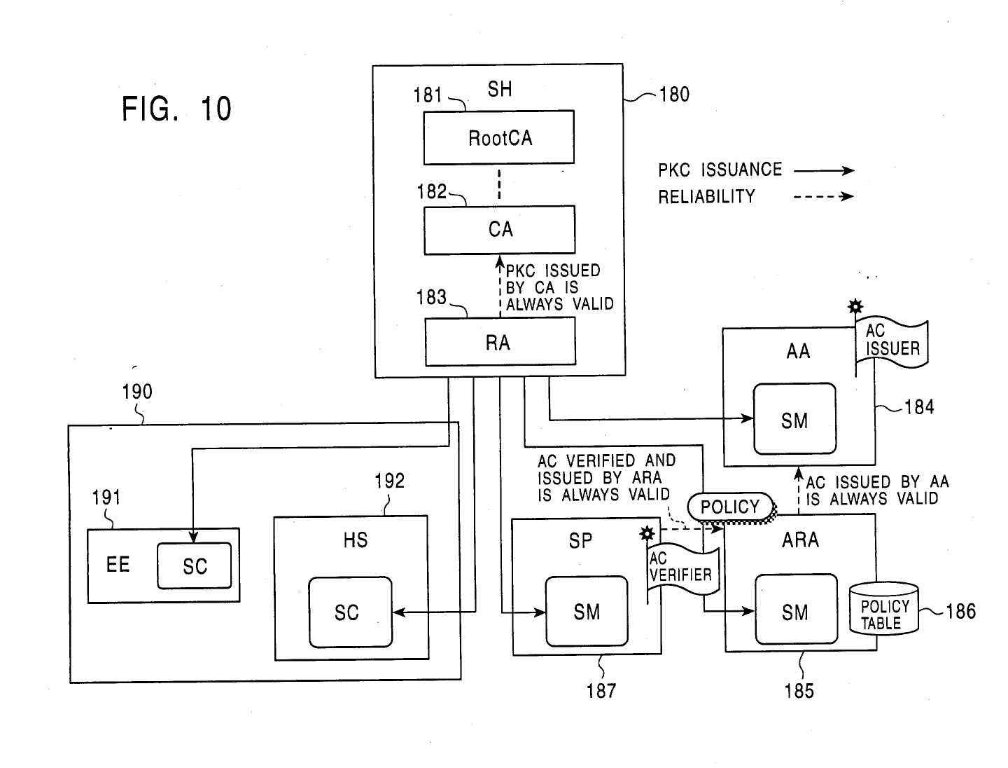

FIG. 10 shows a trust model illustrating the trust relationship between entities participating in the access authorization management, system.

A system holder (SH) 180 is a core for performing the centralized management of the entire access authorization management system of the present invention, that is, the system operating core, and ensures the validity of the security chip (SC) and the security module (SM) of each entity participating in the system, and is responsible for issuing the public key certificate (PKC). The system holder 180 has a root CA (RootCA) 181 as the highest-order certification authority, a plurality of certification authorities (CA) 182 of a hierarchical organization, and a registration authority (RA) 183 as the public key certificate issuing administrative organization.

The system holder (SH) 180 issues a public key certificate (PKC) corresponding to each entity of the attribute certificate authority (AA) 184, the attribute certificate registration authority (ARA) 185, the service provider 187, the home server 192 as the relay server belonging to the domain area 190, and an end entity (EE) 191 as a user device, and each entity stores the public key certificate of the necessary entity.

In the attribute certificate registration authority (ARA) 185 which is set so as to correspond to each entity, an attribute certificate issuing examination for the group attribute certificate (group AC) is performed based on the policies (issuing conditions, etc.) in accordance with a request from each entity of the service provider 187, the home server 192 as the relay server, and the end entity (EE) 191 as the user device. When it is determined that issuing is possible, an issuing request is transferred from the attribute certificate registration authority (ARA) 185 to the attribute certificate authority (AA) 184.

The attribute certificate authority (AA) 184 stores the above-described information such as the domain name, the host name, and the group ID, as the group identification information in the attribute information area in accordance with the group attribute certificate issuing request, and issues the group attribute certificate (see FIG. 5), to which the signature using the private key of the attribute certificate authority (AA) 184 is attached, to the issuance requesting person.

As described above, the attribute certificate authority (AA) 184 and the attribute certificate registration authority (ARA) 185 may be configured in such a manner that the service provider, the home server, or the user device performs the functions thereof.

[(2) Security Chip Configuration]

A description will now be given of the configuration of the security chip (or module) formed in the user device as communication processing devices which performs communication via a communication network, the home server as a relay server, the service provider, etc. The user devices are end entities (EE) as communication processing devices, and include various types of data processing devices, such as PCs, home servers, portable terminals such as PDAs, IC cards, having an interface for performing communication with another communication processing device.

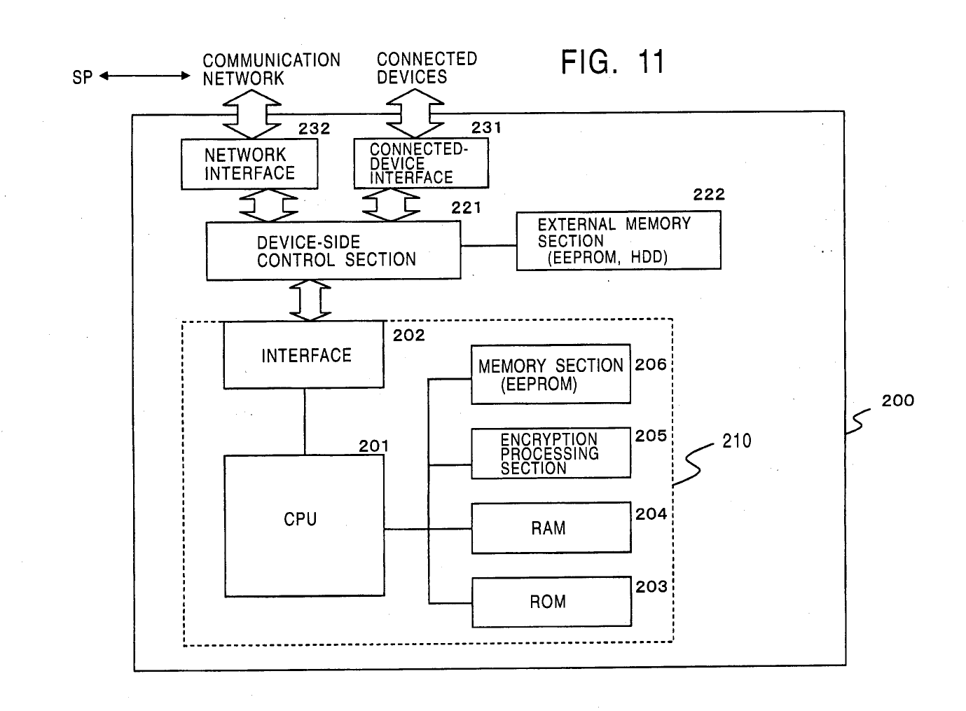

A description will now be given, with reference to FIG. 11, of an example of the configuration of a security chip (or module) formed in the end entity (user device) as a communication processing device, a home server as a relay server, and a service provider.

As shown in FIG. 11, in a device 200 such as a user device (end entity), a home server as a relay server, or a service provider, a security chip 210 is incorporated so as to be capable of transferring data to and from a device-side control section 221.

The security chip 210 has a CPU (Central Processing Unit) 201 having a program execution function and a computation processing function; a communication interface 202 having an interface function for data communication; a ROM (Read Only Memory) 203 storing various programs executed by the CPU 201, for example, an encryption processing program; a RAM (Random Access Memory) 204 which functions as an area to which an execution program is loaded or as a work area in each program process; an encryption processing section 205 for performing an authentication process with an external device, an electronic signature generation and verification process, and an encryption process such as an encryption/decryption process for stored data; and a memory section 206 formed by, for example, an EEPROM (Electrically Erasable Programmable ROM) storing information specific to the device, including various types of key data.

The device 200 has an external memory section 222 formed of an EEPROM as an area for storing encrypted content, service information, etc., a hard disk, etc. The external memory section 222 can also be used as an area for storing public key certificates and group attribute certificates.

When the user device incorporating the security chip is connected to an external entity, for example, another user device connected via a network, a home server as a relay server, or a service provider, and the user device performs a communication process, connection via a network interface 232 is made. However, a user device which does not have the network interface 232 is connected to the end entity (EE) having a communication function via a connected-device interface 231, and performs a communication function via the network interface 232 of the end entity.

In a case where the user device having the security chip shown in FIG. 11, the home server as the relay server, or the service provider is connected, and data transfer is performed between entities, mutual authentication is performed as necessary. The details of these processes will be described in detail later.

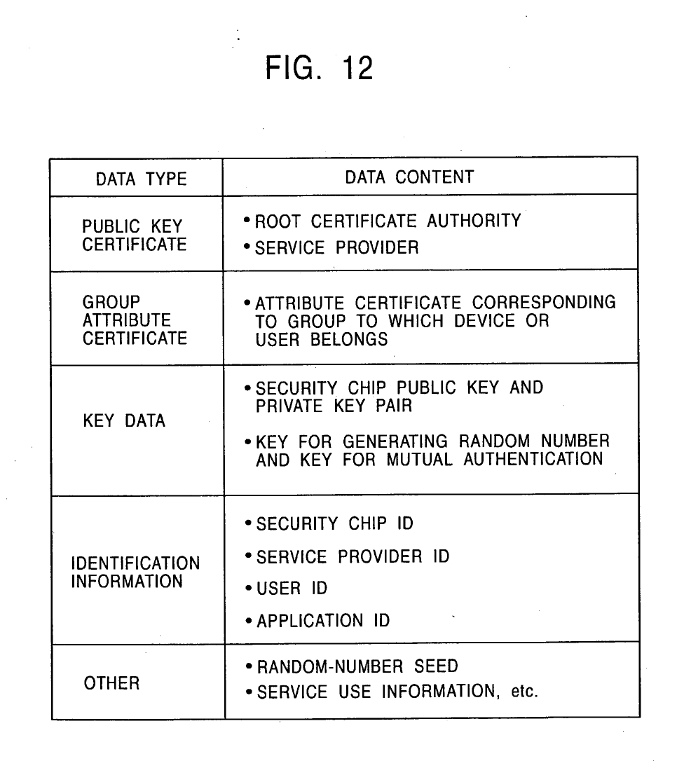

An example of the stored data of the security chip of the user device is shown in FIG. 12. Most of the data is stored in a memory section 206 formed of EEPROM (Electrically Erasable Programmable ROM), such as flash memory, which is one form of a nonvolatile memory, and the public key certificate and the group attribute certificate may be stored either in memory within the security chip or in an external memory.

Each piece of data will now be described.

Public key certificate (PKC): the public key certificate is a certificate showing to a third party that the key is a valid public key, the certificate contains a public key to be distributed, and an electronic signature is attached by a reliable certificate authority. In the user device, there is stored a public key certificate, such as the public key certificate of the above-described highest-order certificate authority (root CA) of the hierarchical organization, or the public key certificate of the service provider which provides services to the user device, which is required to obtain a public key used in the authentication, encryption, or decryption process when data communication with the user device is performed.

Group attribute certificate (AC): while the public key certificate shows the “identity” of the certificate user (owner), the group attribute certificate is used to identify the group of certificate users and to confirm the use authorization provided to a member forming the group. By presenting the group attribute certificate, it becomes possible for the user to perform access on the basis of the right and authorization described in the group attribute certificate. The group attribute certificate is issued based on a predetermined issuing procedure. The details of these processes will be described later.

Key data: as the key data, a pair of the public key and the private key, which is set for the security chip, and a key for generating a random number, a key for mutual authentication, etc., are stored.

Identification information: as the identification information, the security chip ID as the identifier of the security chip itself is stored. Furthermore, the service provider ID as the identifier of the service provider (SP) from which services are continuously received, the user ID assigned to a user who uses the user device, an application ID for identifying an application corresponding to the services provided by the service provider, etc., can be stored.

Other: in the user device, furthermore, there are stored seed information for generating a random number, that is, information for generating a random number used in an authentication process, an encryption process, etc., in accordance with ANSI X9.17; usage information concerning services to which various use limitations are added, for example, information on the number of times of use of content, which is updated when content to which the limitation of the number of times of content use is added; information such as the settlement information; and a hashed value computed based on each piece of information.

The example of the data structure, shown in FIG. 12, is only an example, and in addition, various types of information related to services to be received by the user device can be stored as necessary.

Also, as the means for performing the verification process for the group attribute certificate received via a network interface, which is a data transmission and receiving section, or for executing the generation process for the group attribute certificate, the security chip shown in FIG. 11 is used.

(3) Access Limitation Process

(3-1) Access Limitation Process Overview

A description will now be given of the details of the access limitation process based on the group attribute certificate which is issued to each user or device belonging to a group set in such a manner that a plurality of users belonging to various sets, for example, users belonging to various sets such as the domain name, the host name, organizations, schools, firms, or one family, and devices of the same maker, or users and devices which receive services of the same service provider, are set as a group.

The group attribute certificate is a certificate by which it can be confirmed that a user or device (user device) which is going to perform communication via a network belongs to a specific group. The group attribute certificate is presented to the relay server, such as the home server, which manages the communication processing device (user device) which is a communication party when making an request of access to another communication processing device.

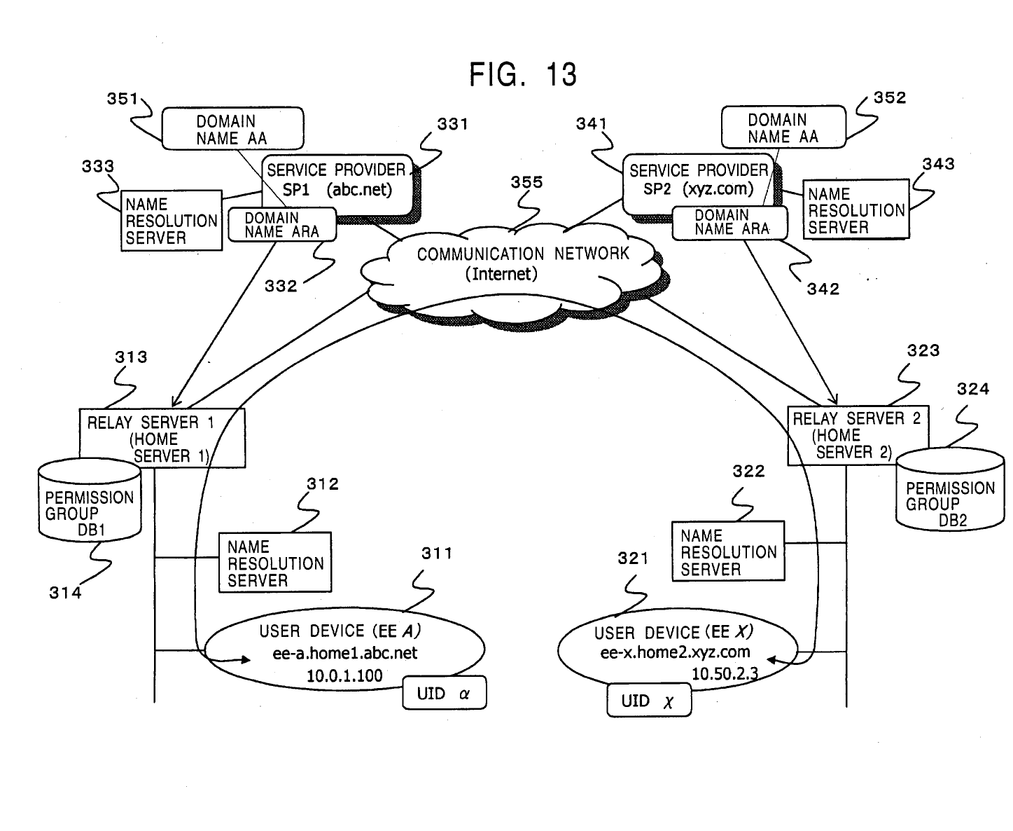

Referring to FIG. 13, the overview of the access authorization management system will now be described. In FIG. 13, a relay server (1) 313, such as a home server, has, as a management terminal, a user device (EE-A) 311 as an end entity communication processing device, and determines as to the permission or non-permission of the access to the user device (EE-A) 311 via a communication network 355 on the basis of an attribute certificate sent from the access requesting source and the stored information of a permission group database 314 in which access permission information is stored.

On the other hand, a relay server (2) 323, such as a home server, has, as a management terminal, a user device 321 as a communication processing device, and determines the permission or non-permission of the access to the user device 321 via the communication network 355 on the basis of an attribute certificate sent from the access requesting source and the stored information of a permission group database 324 in which access permission information is stored.

The user device 311 and the relay server (1) 313 such as the home server are in a specific sub-network name, and are connected via a wired or wireless LAN such as Ethernet, or another communication network.

The relay server (1) 313 of FIG. 13 determines the access authorization for the user device 314 within its own management area on the basis of the group attribute certificate presented from the access requesting source, performs a process of converting a host name into an address by a name resolution server 312 as a DNS (Domain Name System) on condition that it is determined to have access authorization, and notifies the address data to the access requesting source. In a similar manner, the relay server (2) 323 also determines the access authorization of the access request for the user device 324 within its own management area on the basis of the group attribute certificate presented from the access requesting source, and performs similar processes.

A service provider (SP1) 331 shown in FIG. 13 is a service provider belonging to a higher-order domain area of the relay server 313, functions as an attribute certificate registration authority (ARA) which performs the issuing procedure of the domain-name attribute certificate for the relay server 313 or the user device 311. The service provider (SP1) 331 performs the issuing procedure based on the issuing policy in accordance with an attribute certificate issuing request from the relay server 313 or the user device 311, and sends the domain-name attribute certificate issued from a domain-name attribute certificate authority (AA) 351 to the relay server 313 or the user device 311 on condition that the issuing is compliant with the policy.

The service provider (SP2) 341 is a service provider belonging to a higher-order domain of the relay server 323, functions as an attribute certificate registration authority (ARA) which performs the procedure for issuing the domain-name attribute certificate for the relay server 323 or the user device 321. The service provider (SP2) 341 performs an issuing procedure based on the issuing policy in accordance with an attribute certificate issuing request from the relay server 323 or the user device 321, and sends the domain-name attribute certificate issued from the domain-name attribute certificate attribute certificate authority (AA) 352 to the relay server 323 or the user device 321 on condition that the issuing is compliant with the policy.

Furthermore, the service provider (SP1) 331 and the service provider (SP2) 341 perform a process for converting a host name into an address by the corresponding name resolution servers 333 and 343 in the communication process via the communication network 355, and perform a process for notifying the address data to the access requesting source.

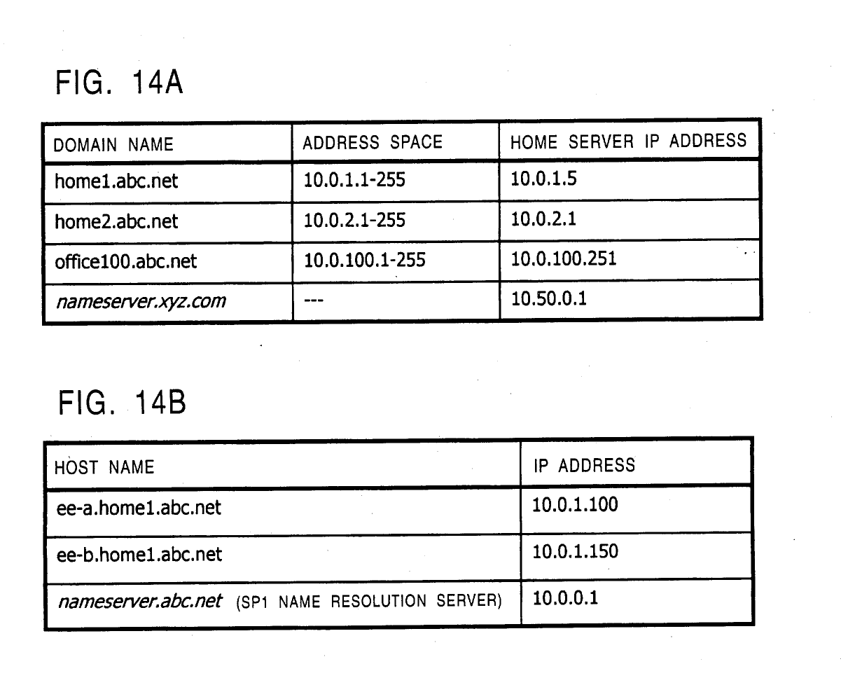

Examples of databases possessed by the name resolution server 333 used by the service provider (SP1) 331 and the name resolution server 312 used by the relay server 313 are shown in FIGS. 14A and 14B.

FIG. 14A shows an example of the database of the name resolution server 333 used by the service provider (SP1) 331. In the database, each data of the address space corresponding to the domain name corresponding to the domain under the control of the abc.net domain to which the service provider (SP1) 331 belongs, and the IP address of the home server as the relay server is stored.

FIG. 14B shows an example of the database of the name resolution server 312 used by the relay server 313. In the database, the IP address corresponding to the host name of the device belonging to the home1.abc.net domain to which the name resolution server 312 belongs is stored, and further, the IP address data of the name resolution server of the higher-order domain, that is, the name resolution server 333 in the configuration of FIG. 13, is stored.

In the communication process via the communication network, the service provider and the relay server such as the home server receive the host name from the access requesting source, obtain the address by using the name resolution server, notify the address information to the access requesting source, and perform a process in which communication based on the address is possible.

(3-2) Domain Registration and Attribute Certificate Issuing Processes

A description will now be given of a domain registration application process and a process for obtaining a domain-name attribute certificate.

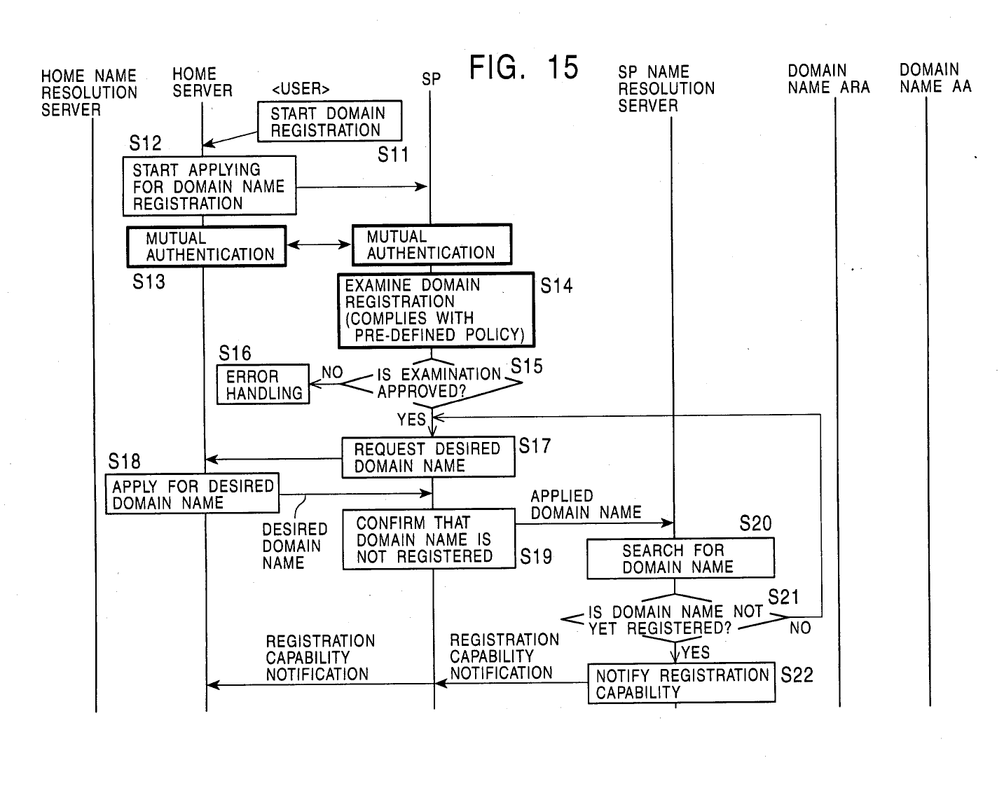

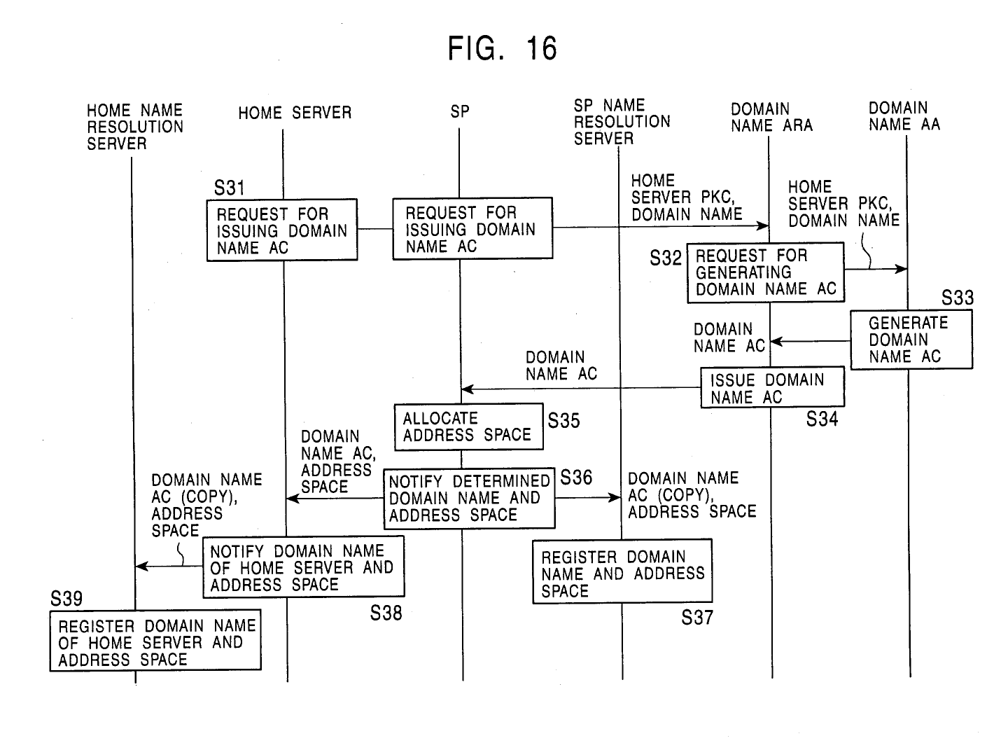

Referring to FIGS. 15 and 16, a description is given of a domain registration application process by the home server which manages user devices as one or more communication processing devices and a process for obtaining a domain-name attribute certificate.

In FIGS. 15 and 16,

Home name resolution server: a name resolution server used by the home server,

Home server: a relay server for performing name resolution using the home name resolution server on the basis of examination based on an attribute certificate,

Service provider (SP): a service provider for assigning a domain name to the home server,

SP name resolution server: a name resolution server used by the service provider (SP) to perform name resolution,

Domain name ARA: a domain-name attribute certificate registration authority, and

Domain name AA: a domain-name attribute certificate authority.

FIG. 15 shows the domain registration application processing procedure by the home server. In step S11, when the user inputs a domain registration start processing command to the home server. Then, in step S12, the home server transmits a domain registration application to the management service provider of the domain to which the home server belongs.

In step S13, a mutual authentication process is performed between the home server and the service provider receiving the domain registration application. The mutual authentication is a process which is performed to mutually confirm whether or not the other party is a proper data communication party between two end entities for performing data transmission and reception. Necessary data transfer is performed on condition that the authentication is approved. It is preferable that a session key be generated during the mutual authentication process, the generated session key be used as a shared key, and thereafter, transfer of data on which an encryption process based on the session key is performed be performed. As the mutual authentication method, a public key encryption method, a common key encryption method, etc., can be used.

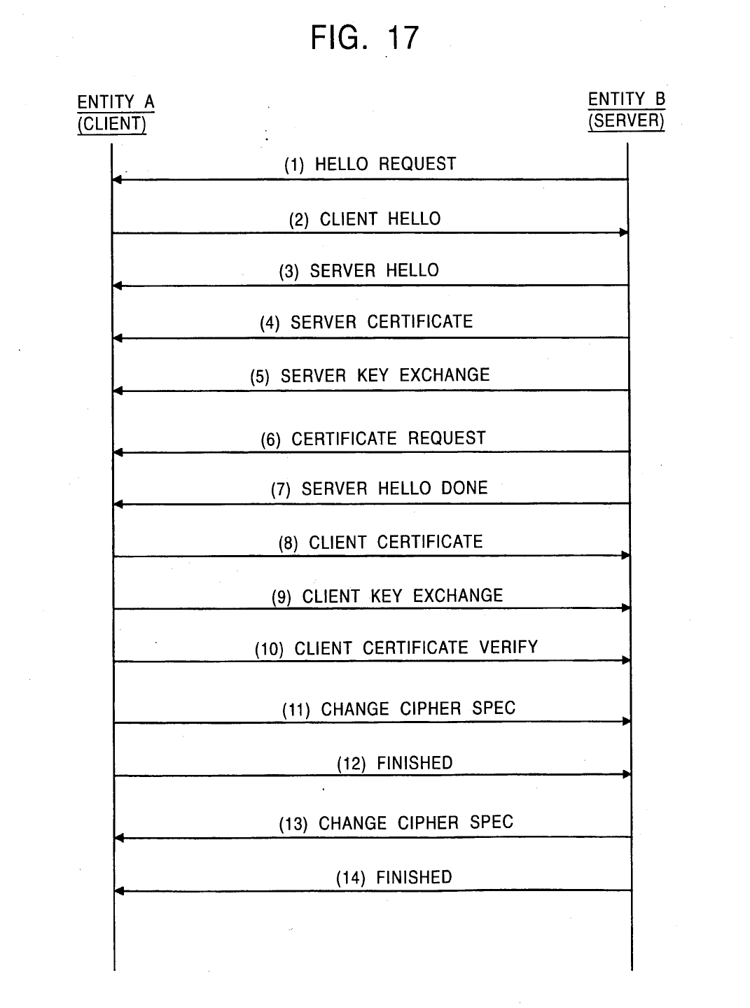

Here, a description will now be given of a hand-shake protocol (TLS 1.0), which is one authentication processing method of the public key encryption method, with reference to the sequence diagram of FIG. 17.

In FIG. 17, an entity A (client) and an entity B (server) are two entities which perform communication, and here, these correspond to the home server and the service provider, respectively. First, (1) the entity B transmits a negotiation starting request for determining the encryption specification as a hello request to the entity A. (2) When the entity A receives the hello request, the entity A transmits candidates for the encryption algorithm to be used, the session ID, and the protocol version as client hello to the entity B.

(3) The entity B transmits the encryption algorithm, the session ID, and the protocol version, which are determined to be used, as server hello to the entity A. (4) The entity B transmits (server certificate) a suite of public key certificates (X.509v3) up to the root CA, which are owned by the entity B itself. When verification up to the highest-order public key certificate in sequence by tracing back the certificate chain is not performed, it is not always necessary to transmit a suite of public key certificates (X.509v3) up to the root CA. (5) The entity B transmits (server key exchange) the RSA public key or the Diffie & Hellman public key information to the entity A. This is public key information which is temporarily used when the certificate cannot be used.

(6) Next, the entity B requests, as a certificate request, a certificate possessed by the entity A to the entity A. (7) The termination of the negotiation process by the entity B is notified (server hello termination).

(8) The entity A receiving the server hello termination transmits (client certificate) a suite of public key certificates (X.509v3) up to the root CA, which are possessed by the entity A itself, to the entity B. If the chain verification of the public key certificates is not performed, the sending of a suite of public key certificates is not required. (9) The entity A encrypts a 48-bit random number by using the public key of the entity B and transmits it to the entity B. On the basis of this value, the entity B and the entity A generate a master secret containing data for generating a message authentication code (MAC) for the transmission/receiving data verification process.

(10) In order to confirm the validity of the client certificate, the entity A encrypts the digest of the messages up to this point by using the private key of the client and transmits (client certificate confirm) it to the entity B. (11) The starting the use of the above-determined encryption algorithm and the key is notified (change cipher specification). (12) The termination of the authentication is notified. On the other hand, (13) the starting of the use of the above-determined encryption algorithm and the key is also notified (change cipher specification) from the entity B to the entity A. (14) The termination of the authentication is notified.

The transfer of data is performed between the entity A and the entity B in accordance with the encryption algorithm which is determined in the above-described processes.

The verification of the data falsification is performed in such a manner that the message authentication code (MAC) computed from the master secret generated by mutual consent between the entity A and the entity B in the authentication process is added to the transmission data of each entity.

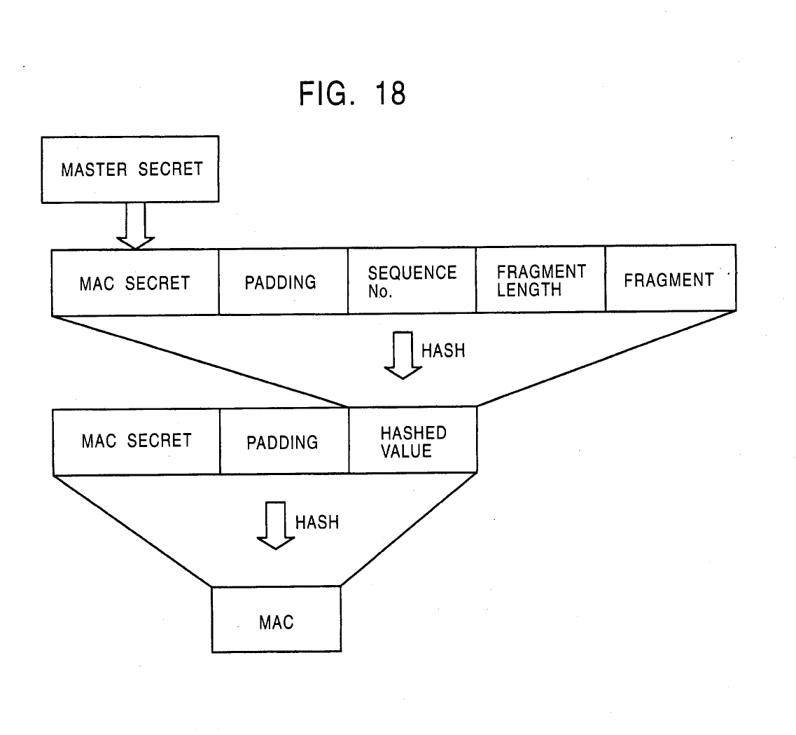

FIG. 18 shows the generation structure of the message authentication code (MAC). The data transmission side adds to the transmission data a MAC secret generated on the basis of the master secret generated in the authentication process, calculates a hashed value from the entire data, and performs hash computation based on the MAC secret, padding, and the hashed value in order to generate the message authentication code (MAC). This generated MAC is added to the transmission data, and if the matching between the MAC generated on the basis of the received data on the receiving side and the received MAC is recognized, it is determined that there is no data falsification; if the matching is not recognized, it is determined that there is data falsification.

In step S13 shown in FIG. 15, for example, a mutual authentication process in compliance with the above-described sequence is performed between the home server and the service provider (SP). If it is confirmed that both are proper communication parties, in step S14, the service provider (SP) performs the examination of the domain registration in accordance with a pre-defined policy. If the examination is not approved, error handling, for example, a process for notifying the home server that a registration process cannot be performed is performed.

If the examination is approved, in step S17, a request for a desired domain name is made to the home server. In step S18, when the home server transmits the desired domain name to the service provider (SP), the service provider performs a process of confirming that a domain name is not registered. This is performed as processes of step S20 and subsequent steps. A domain name which is applied for is transmitted from the service provider to the SP name resolution server administered by the service provider, and the SP name resolution server searches for the domain name in order to determine whether or not the domain name which is applied for is not yet registered. When the domain name which is applied for is registered, the process returns to step S17, where the desired domain name is requested again.

When the domain name which is applied for is not registered, the process proceeds to step S22, where the registration-possible notification is transmitted to the service provider and is further transmitted from the service provider to the home server.

Referring to FIG. 16, a description will now be given of a processing procedure for a request for issuing the domain-name attribute certificate (domain name AC), which is performed by the home server where the domain is registered.

In step S31, the home server requests the domain-name attribute-certificate registration authority (ARA) to issue the domain-name attribute certificate (domain name AC) via the service provider. At this time, the public key certificate (PKC) of the home server, and the registered domain name are transmitted as additional data.

When the domain-name attribute-certificate registration authority (ARA) performs examination in accordance with the policy on the basis of the issuing request and determines that the issuing conditions are satisfied, in step S32, the domain-name attribute-certificate registration authority (ARA) requests the domain-name attribute certificate authority (AA) to issue the domain-name attribute certificate together with the public key certificate (PKC) of the home server and the registered domain name.

In step S33, the domain-name attribute certificate authority (AA) creates a domain-name attribute certificate on the basis of the public key certificate (PKC) of the home server and the registered domain name, and transmits the domain-name attribute certificate to the domain-name attribute-certificate registration authority (ARA). The domain-name attribute certificate created here has the structure described above with reference to FIG. 7A, where the domain name is stored in the attribute information field and a signature using the private key of the domain-name attribute certificate authority (AA) is attached.

The domain-name attribute-certificate registration authority (ARA) transmits the received domain-name attribute certificate to the service provider. In step S35, the service provider allocates the address space corresponding to the domain name of the home server. In step S36, the service provider transmits the determined address space corresponding to the domain name and the domain-name attribute certificate to the home server, and further transmits the determined address space corresponding to the domain name and a copy of the domain-name attribute certificate (AC) to the SP name resolution server. The SP name resolution server registers the address space corresponding to the domain name in the database (see FIG. 14A).

The home server receiving the address space corresponding to the domain name and the domain-name attribute certificate (AC) transmits the determined address space corresponding to the domain name and a copy of the domain-name attribute certificate (AC) to the home name resolution server used by the home server. The home name resolution server registers the address space corresponding to the domain name in the database (see FIG. 14B).

In the above-described processes, after the home server receiving the domain-name attribute certificate (AC) verifies the signature thereof in order to confirm that the domain-name attribute certificate (AC) has not been falsified, the home server stores the domain-name attribute certificate (AC) in its own memory, and creates a copy thereof.

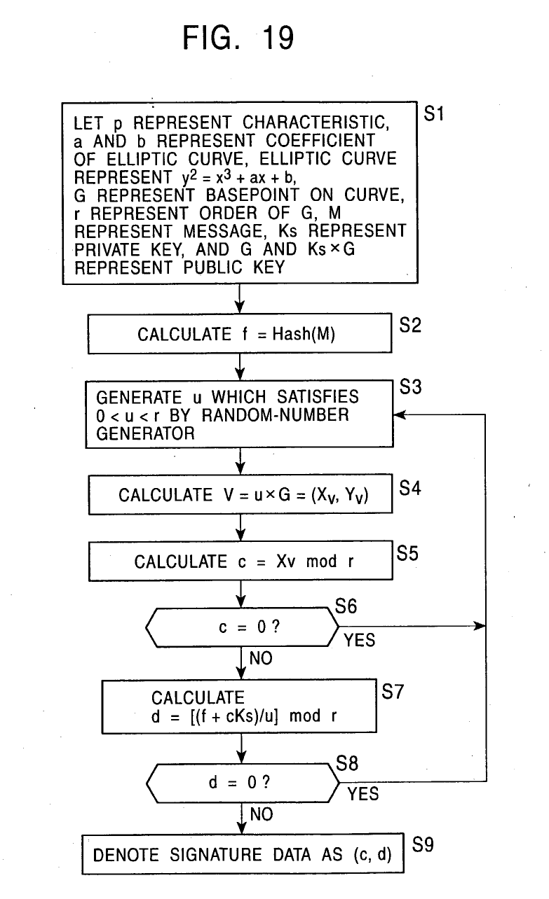

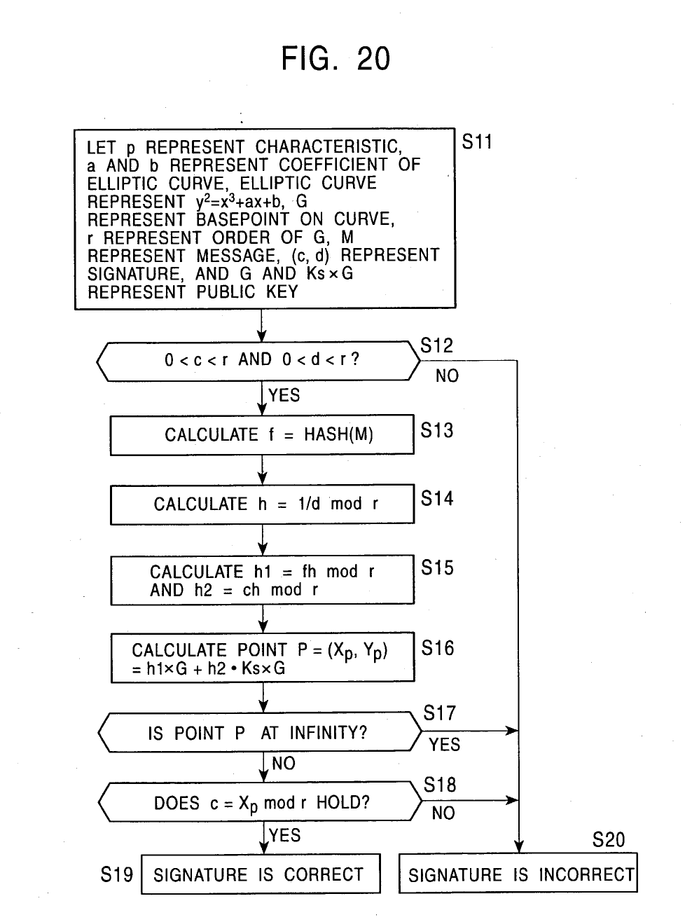

A description will now be given, with reference to FIGS. 19 and 20, of the generation of the electronic signature, which is performed by the attribute certificate authority (AA) when the attribute certificate is created and of the process for verifying the electronic signature, performed by the home server when the attribute certificate is stored.

The signature is attached to enable the verification of data falsification. The above-described MAC value can also be used, and an electronic signature using the public key encryption method can also be used.

The method of generating the electronic signature using the public key encryption method is described first with reference to FIG. 19. The processing shown in FIG. 19 is an electronic signature data generation processing flow using EC-DSA (Elliptic Curve Digital Signature Algorithm, IEEE P1363/D3). Here, an example is described in which elliptic curve cryptosystem (hereinafter referred to as an “ECC”) is used as public key cryptosystem. In the data processing device of the present invention, in addition to the elliptic curve cryptosystem, for example, RSA encryption (Rivest, Shamir, Adleman, etc., (ANSI X9.31)) in a similar public key cryptosystem can be used.

Each step in FIG. 19 will now be described. In step S1, let p represent a characteristic, a and b represent a coefficient on an elliptic curve (elliptic curve: y²=x³+ax+b, 4a³+27b²≠0 (mod p)), G represent a basepoint on the elliptic curve, r represent the order of G, Ks represent a private key (0<Ks<r). In step S2, the hashed value of a message M is calculated, and it is set that f=Hash(M).

A description will now be given of a method for determining the hashed value by using a hash function. The hash function is a function in which a message is an input, this is compressed to data of a predetermined bit length, and it is output as the hashed value. The hash function has features that it is difficult to predict an input from the hashed value (output), when one bit of the data input to the hash function changes, many bits of the hashed value change, and it is difficult to find different input data having the same hashed value. As the hash function, there are cases in which MD4 (Message Digest), MD5, SHA-1 (Secure Hash Algorithm, revision 1), etc., are used, and DES-CBC is sometimes used. In this case, the MAC which is the final output value (the check value: corresponding to ICV (Integrity Check Value)) becomes the hashed value.

Next, in step S3, a random number u (0<u<r) is generated, and in step S4, a coordinate V (Xv, Yv) such that the basepoint is multiplexed by u is calculated. The addition and the double multiplication on the elliptic curve are defined as described below:

If P=(Xa, Ya), Q=(Xb, Yb), and R=(Xc, Yc)=P+Q,

when P≠Q (addition),

Xc=λ²−Xa−Xb,

Yc=λ×(Xa−Xc)−Ya, and

λ=(Yb−Ya)/(Xb−Xa),

when P=Q (double multiplication),

Xc=λ²−2Xa,

Yc=λ×(Xa−Xc)−Ya, and

λ=(3(Xa)²+a)/(2Ya)

The point G multiplexed by u is calculated using the above. Although the speed is slow, the most understandable method is: G, 2×G, 4×G . . . are calculated, and 2ⁱ×G (value such that double multiplication of G is performed for i times (i indicates the bit position when counting from the LSB of u)) corresponding to the place where u is subjected to binary expansion and “1” is set is added.

In step S5, c=Xv mod r is calculated, and in step S6, a determination is made as to whether or not this value is 0. If it is not 0, in step S7, d=[(f+cKs)/u] mod r is calculated. It is determined in step S8 whether or not d is 0. If d is not 0, in step S9, c and d are output as the electronic signature data. If it is assumed that r is of a 160-bit length, the electronic signature data becomes 320 bits long.

In step S6, when it is determined that c is 0, the process returns to step S3, where a new random number is generated again. Also, in a similar manner, when d is 0 in step S8, the process returns to step S3, where a random number is generated again.

A description will now be given, with reference to FIG. 20, of a method of verifying the electronic signature by using the public key encryption method. In step S11, let M represent a message, a and b represent coefficients on an elliptic curve (elliptic curve: y²=x³+ax+b, 4a³+27b²≠0 (mod p)), G represent a basepoint on the elliptic curve, r represent the order of G, and G and Ks×G represent a public key (0<Ks<r). In step S12, it is verified whether or not the electronic signature data c and d satisfy 0<c<r and 0<d<r. When these are satisfied, in step S13, the hashed value of the message M is calculated, and it is set that f=Hash(M). Next, in step S14, h=1/d mod r is calculated, and in step S15, h1=fh mod r and h2=ch mod r are calculated.

In step S16, by using h1 and h2, which have already been calculated, point P=(Xp, Yp)=h1×G+h2·Ks×G is calculated. Since the electronic signature verifier knows the basepoint G and Ks×G, a calculation of scalar multiplication of the point on the elliptic curve can be performed similarly to that in step S4 of FIG. 19. Then, in step S17, it is determined whether or not the point P is at infinity, and if it is not at infinity, the process proceeds to step S18 (in practice, the determination as to the point at infinity can be made in step S16. That is, it has been determined that, if the addition of P=(X, Y) and Q=(X, Y) is performed, λ cannot be calculated, and P+Q is at infinity). In step S18, Xp mod r is calculated, and this is compared with the electronic signature data c. Finally, when these values match, the process proceeds to step S19, where the electronic signature is determined to be correct.

When the electronic signature is determined to be correct, it can be seen that the data has not been falsified and the person owning the private key corresponding to the public key has generated the electronic signature.

In step S12, when the electronic signature data c or d does not satisfy 0<c<r or 0<d<r, the process proceeds to step S20. Also, when the point P is at infinity in step S17, the process proceeds to step S20. Furthermore, when the value of Xp mod r does not match the electronic signature data c, the process proceeds to step S20.

When it is determined in step S20 that the electronic signature is incorrect, it can be seen that the data has been falsified or the person owning the private key corresponding to the public key has not generated the electronic signature. As described above, only attaching a signature and calculating a hash cannot eliminate falsification, but detection has substantially the same effect as that falsification cannot be performed.

The above-described generation and verification of the electronic signature make it possible to prevent use of a falsified attribute certificate. Also, when performing a process for confirming access authorization using the attribute certificate, the signature verification of the attribute certificate is performed. This process will be described later.

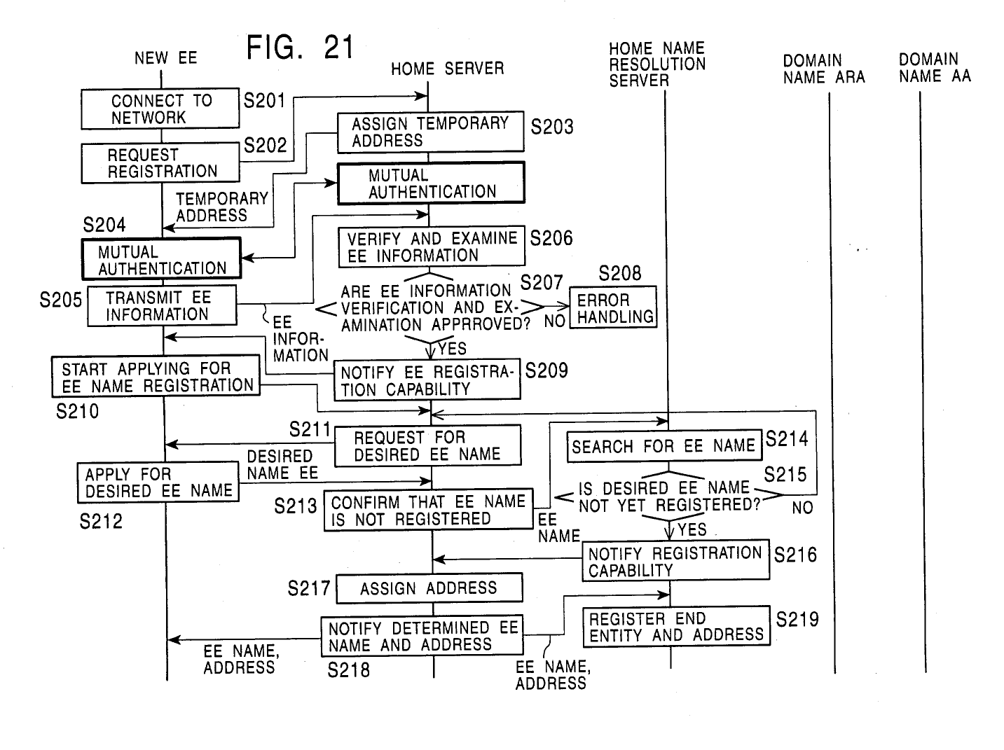

A description will now be given, with reference to FIGS. 21 to 23, of a sequence in which an end entity (EE) is newly added as a communication processing device (user device) and of issuing a domain-name attribute certificate for the end entity (EE) and a host-name attribute certificate.

In FIGS. 21 to 23,

New EE: an end entity added as a new communication processing device under the control of the home server,

Home server: a relay server which performs name resolution using the home name resolution server on the basis of examination based on the attribute certificate,

Home name resolution server: a name resolution server used by the home server,

Domain name ARA: a domain-name attribute certificate registration authority,

Domain name AA: a domain-name attribute certificate authority.

Initially, in step S201 in FIG. 21, a new EE (end entity) as a communication processing device is connected to a network. Then, in step S202, the new EE (end entity) outputs a registration request to the home server. This new EE has a configuration described with reference to, for example, FIG. 11, and is connected to a network via the network interface 232 (see FIG. 11).

The home server assigns a temporary address with respect to a registration request from the new EE (S203). Thereafter, mutual authentication is performed between the new EE and the home server (S204). This mutual authentication process is performed in accordance with the sequence described above with reference to, for example, FIG. 17. On condition that the mutual authentication is approved, the process proceeds to the subsequent step. The new EE transmits the device information necessary for a registration process to the home server (S205), and the home server performs the verification and examination of the received information (S206).

When the verification and examination results show that registration is impossible (No in step S207), error handling (S208) is performed, and the processing is terminated. When the verification and examination results show that registration is possible (Yes in step S207), a registration-possible notification is transmitted to the new EE (S209). When the registration-possible notification is received, the new EE transmits the EE name (host name) registration application to the home server (S210). The home server requests the desired EE name (host name) to the new EE (S211). Then, the new EE transmits the desired EE name (host name) to the home server (S212).

When the new EE transmits the desired EE name (host name) to the home server, the home server performs a process of confirming that the EE name (host name) is not registered (S213). This is performed as processes of step S214 and subsequent steps. The desired EE name (host name) is transmitted from the home server to the home name resolution server. The home name resolution server searches for the desired EE name (host name) in order to determine whether or not the desired EE name (host name) is not registered. When the desired EE name (host name) is registered, the process returns to step S211, where a request for the desired EE name (host name) is made again.

When the desired EE name (host name) is not registered, the process proceeds to step S216, where the registration-possible notification is transmitted to the home server. The home server assigns the address space corresponding to the EE name (host name) (S217). In step S218, the home server notifies the determined EE name (host name) and the corresponding address to the newly registered EE, and further transmits the determined EE name (host name) and the corresponding address to the home name resolution server. The home name resolution server registers the address space corresponding to the host name in the database (see FIG. 14B).

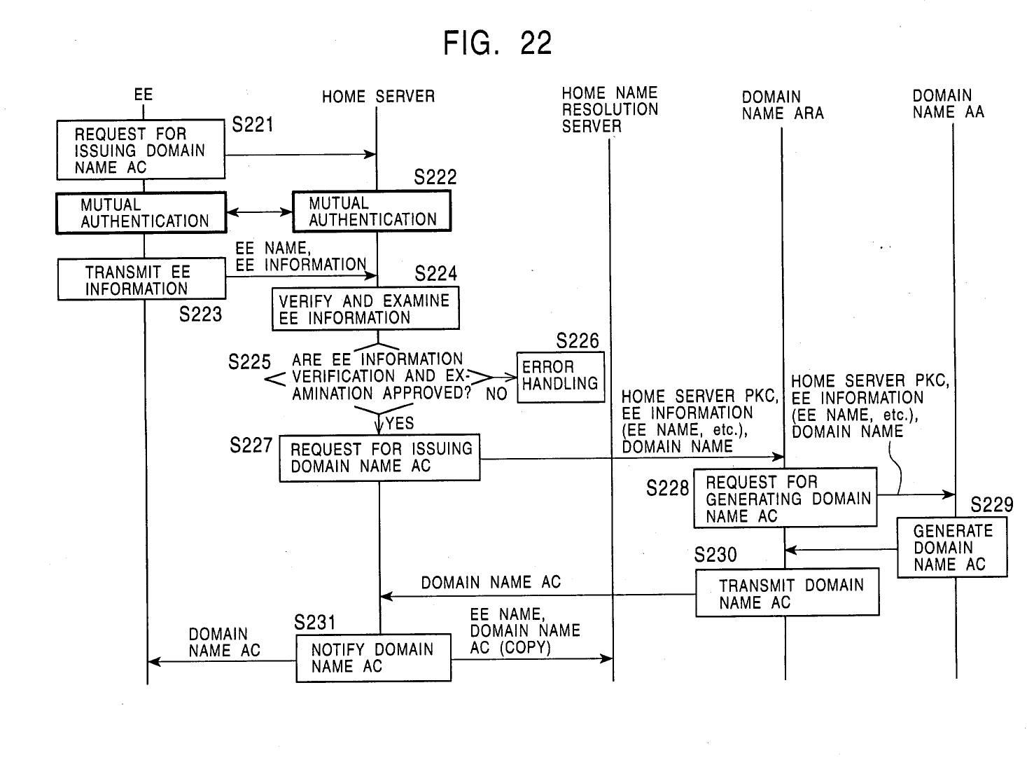

A description will now be given, with reference to FIG. 22, of a processing procedure for a request for issuing the domain-name attribute certificate (domain name AC), which is performed by the end entity (EE).

Initially, in step S221, the EE (end entity) outputs a request for issuing a domain-name attribute certificate (domain name AC) to the home server. When the request from the EE is received, the home server performs mutual authentication between the EE and the home server (S222). This mutual authentication process is performed in accordance with the sequence described above with reference to, for example, FIG. 17. On condition that the mutual authentication is approved, the process proceeds to the subsequent step. The EE transmits to the home server, the device information and the host name (EE name) required for a process of issuing the domain-name attribute certificate (domain name AC) (S223), and the home server performs the verification and examination of the received information (S224).

When the verification and examination results show that the domain-name attribute certificate (domain name AC) cannot be issued (No in step S225), an error-handling process (S226) is performed, and the processing is terminated. When the verification and examination results show that the domain-name attribute certificate (domain name AC) can be issued (Yes in step S225), in step S227, the home server makes a domain-name attribute certificate (domain name AC) issuing request to the domain-name attribute-certificate registration authority (ARA). At this time, the public key certificate (PKC) of the home server, the device information of the EE, the host name (EE name), and the domain name are transmitted as additional data.

The domain-name attribute-certificate registration authority (ARA) performs examination based on the attribute certificate issuing policy in accordance with the issuing request. When it is determined that the issuing conditions are satisfied, in step. S228, the domain-name attribute-certificate registration authority (ARA) notifies the public key certificate (PKC) of the home server, the device information of the EE, the host name (EE name), and the domain name to the domain-name attribute certificate authority (AA), and makes a request for issuing the domain-name attribute certificate.

In step S229, the domain-name attribute certificate authority (AA) creates a public key certificate (PKC) of the home server and the domain-name attribute certificate based on the registered domain name, and transmits these to the domain-name attribute-certificate registration authority (ARA). The domain-name attribute certificate to be created here has the structure described above with reference to FIG. 7A, and is formed such that the domain name is stored in the attribute information field and a signature using the private key of the domain-name attribute certificate authority (AA) is attached.

The domain-name attribute-certificate registration authority (ARA) transmits the received domain-name attribute certificate to the home server (S230). In step S231, the home server transmits the domain-name attribute certificate (AC) to the end entity (EE), and further transmits the host name and a copy of the domain-name attribute certificate (AC) to the home name resolution server.

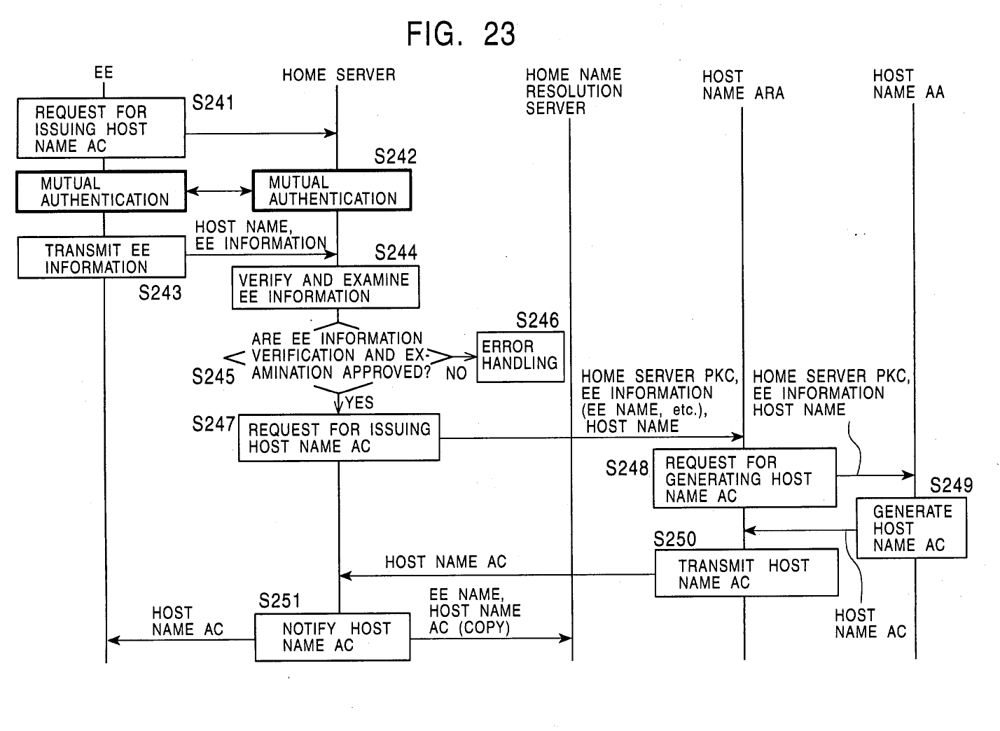

A description will now be given, with reference to FIG. 23, of a processing procedure for a request for issuing a host-name attribute certificate (host name AC), which is performed by the end entity (EE).

In FIG. 23,

New EE: an end entity which is added as a new communication processing device under the control of the home server,

Home server: a relay server which performs name resolution using the home name resolution server on the basis of examination in accordance with the attribute certificate,

Home name resolution server: a name resolution server used by the home server,

Host name ARA: a host-name attribute certificate registration authority,

Host name AA: a host-name attribute certificate authority.

Initially, in step S241, the EE (end entity) outputs a request for issuing a host-name attribute certificate (host name AC) to the home server. When the home server receives the request from the EE, mutual authentication is performed between the EE and the home server (S242). This mutual authentication process is performed in accordance with the sequence described above with reference to, for example, FIG. 17. On condition that the mutual authentication is approved, the process proceeds to the subsequent step. The EE transmits device information and the host name (EE name) required for a process for issuing the host-name attribute certificate (host name AC) to the home server (S243). Then, the home server performs the verification and examination of the received information (S244).

When the verification and examination results show that the host-name attribute certificate (host name AC) cannot be issued (No in step S245), an error-handling process (S246) is performed, and the processing is terminated. If the verification and examination results show that the host-name attribute certificate (host name AC) can be issued (Yes in step S245), in step S247, the home server requests the host-name attribute certificate registration authority (ARA) to issue the host-name attribute certificate (host name AC). At this time, the public key certificate (PKC) of the home server, the device information of the EE, and the host name (EE name) are transmitted as additional data.

The host-name attribute certificate registration authority (ARA) performs examination based on the policy in accordance with the issuing request. When it is determined that the issuing conditions are satisfied, in step S248, the host-name attribute certificate registration authority (ARA) requests the host-name attribute certificate authority (AA) to issue a host-name attribute certificate together with the public key certificate (PKC) of the home server, the device information of the EE, the host name (EE name), and the host name.

In step S249, the host-name attribute certificate authority (AA) creates a host-name attribute certificate on the basis of the public key certificate (PKC) of the home server and the registered host name, and transmits the host-name attribute certificate to the host-name attribute certificate registration authority (ARA). The host-name attribute certificate created here has the configuration described above with reference to FIG. 7A, and is formed in such a manner that the host name is stored in the attribute information field and a signature is attached using the private key of the host-name attribute certificate authority (AA).

The host-name attribute certificate registration authority (ARA) transmits the received host-name attribute certificate to the home server (S250). In step S251, the home server transmits the host name attribute certificate (AC) to the end entity (EE), and further transmits the host name and a copy of the host-name attribute certificate (AC) to the home name resolution server.

In the above-described processes, after the end entity (EE) receiving the host name attribute certificate (AC) verifies the signature thereof and confirms that the domain name attribute certificate (AC) has not been falsified, the end entity (EE) stores it in its memory.

(3-3) Access Permission Information Registration and Deletion Processes

A description will now be given of access permission information registration and deletion processes. For example, in the configuration shown in FIG. 13, the user device 311 as the end entity (EE) is able to register, in a relay server 1 (home server 1) 313, a group of access requesting sources for which connection is permitted with regard to the request of access to the user device 311 itself. On the other hand, the user device 321 is able to register, in a relay server 2 (home server 2) 323, a group of access requesting sources for which connection is permitted with regard to the request of access to the user device 321 itself.

The relay server (1) 313 receives an access request permission group information for its terminal (user device 311) from the user device managed by the relay server (1) 313 itself, that is, a terminal (for example, the user device 311 in FIG. 13) capable of providing name resolution process services using the name resolution server 312, and registers the information.

The relay server (1) 313 determines the access capability on the basis of the registered information, the domain-name attribute certificate presented from the access requesting source, the host-name attribute certificate, and another group attribute certificate, performs a name resolution process only when the access requesting source belongs to the group for which access is permitted in order to obtain the address from the host name, and notifies the address to the access requesting source.

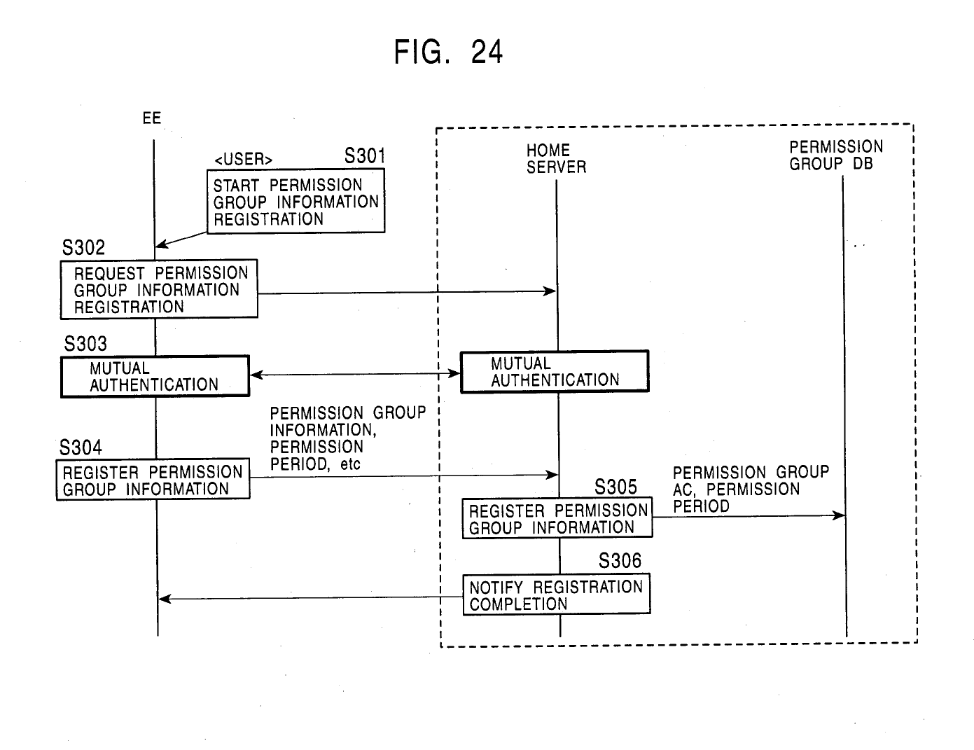

A description will now be given, with reference to FIG. 24, of a sequence in which the end entity (EE), which is a user device, registers the access permission group information in the home server which performs the name resolution process of its own device. In FIG. 24,

EE: an end entity (user device) which requests the registration of the access permission information,

Home server: a home server which determines name resolution based on the host name of the EE in accordance with the attribute certificate presented from the access requesting source and the registered access permission information, and

Permission group database: a database for registering the access permission information.

Initially, in step S301, the user inputs a request for starting the permission group information registration to the end entity (EE), which is a user device, via the interface of the EE. In step S302, the EE outputs a permission group information registration request to the home server which determines the execution of its own name resolution process.

Next, in step S303, mutual authentication is performed between the home server and the end entity (EE). This mutual authentication process is performed in accordance with the sequence described above with reference to, for example, FIG. 17. On condition that the mutual authentication is approved, the process proceeds to the subsequent step. In step S304, the EE transmits, to the home server, information required for a registration process, such as the group information for which access is permitted and the access permission period.

The home server performs a registration process for the permission group database (DB) in accordance with the received information (S305). After the registration, the home server transmits the registration completion notification to the end entity (EE) (S306), and the registration process is terminated.

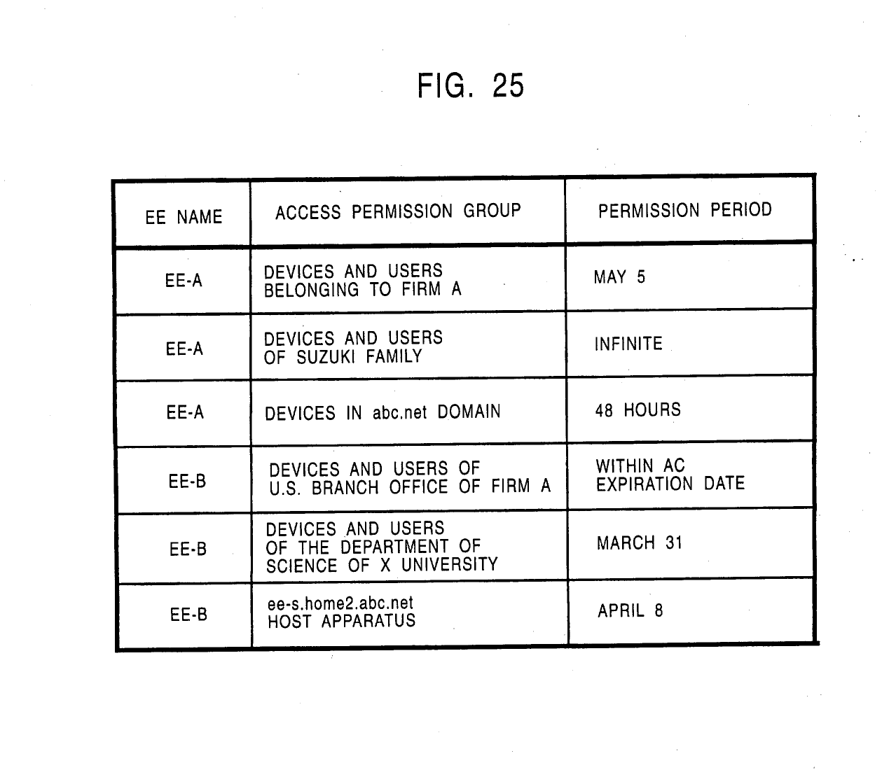

An example of the configuration of the permission group database is shown in FIG. 25. FIG. 25 shows an example in which an access permission group for two EEs, that is, an end entity (ee-a) and an end entity (ee-b), is registered.

In the end entity (ee-a), information is registered such that, for devices and users of firm A, access is permitted until May 5; for devices and users of Suzuki family, access is permitted infinitely; and for devices in the abc.net domain, access within 48 hours from setting is permitted. In the end entity (ee-b), information is registered such that, for devices and users of a branch office of firm A in the United States, access is permitted within the expiration date of the presented attribute certificate; for devices and users of Science Faculty of X University, access is permitted until March 31; and for host name devices of ee-s.home2.abc.net, access from setting to April 8 is permitted.

The home server having the permission group database shown in FIG. 25 determines whether or not the access requesting source belongs to the access permission group on the basis of the attribute certificate presented from the access requesting source. When it is determined that it belongs to the access permission group, the address is obtained by the name resolution process from the host name of the device (EE) of the access request destination, and the address is notified to the access requesting source.

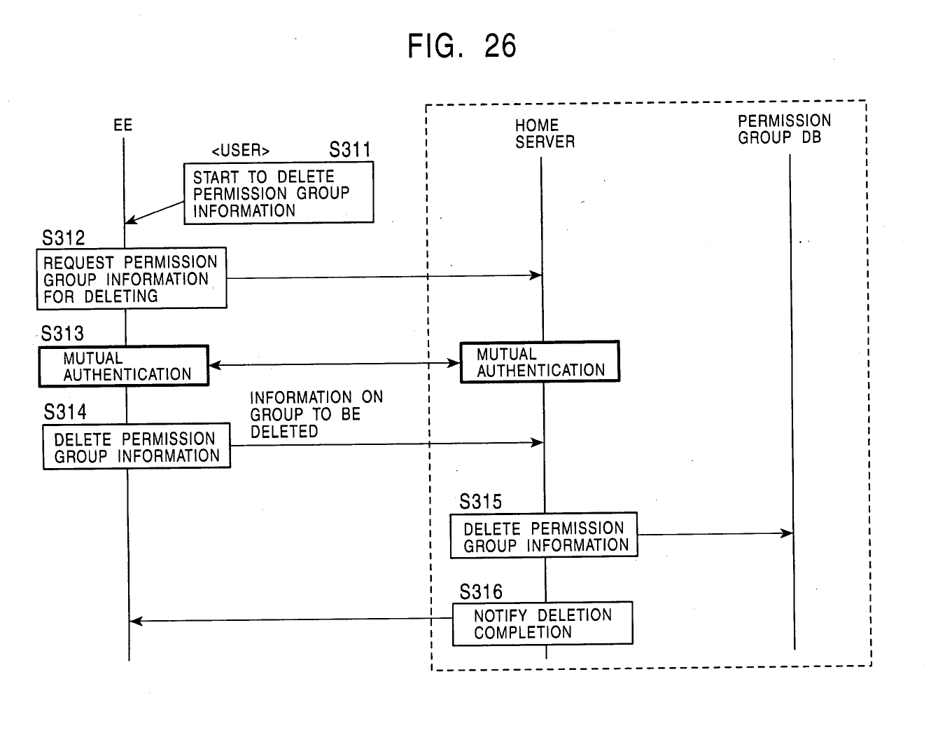

A description will now be given, with reference to FIG. 26, of a sequence in which the access permission group information is deleted. In FIG. 26,

EE: an end entity (user device) which requests the registration of access permission information,

Home server: a home server which determines name resolution based on the host name of the EE in accordance with the attribute certificate presented from the access requesting source and the registered access permission information, and

Permission group database: a database for registering the access permission information.

Initially, in step S311, the user inputs, to an end entity (EE), which is a user device, a request for starting the deletion of the permission group information via the interface of the EE. In step S312, the EE outputs a request for starting the deletion of the permission group information to the home server which determines the execution of its own name resolution process.

Next, in step S313, mutual authentication is performed between the home server and the end entity (EE). This mutual authentication process is performed in accordance with the sequence described above with reference to, for example, FIG. 17. On condition that the mutual authentication is approved, the process proceeds to the subsequent step. In step S314, the EE transmits information required for a deletion process, that is, group information to be deleted, to the home server.

The home server performs a process of deleting the registration information of the permission group database (DB) (S315), and after the deletion, the deletion completion notification is transmitted to the end entity (EE) (S316), and the registration process is terminated.

(3-4) Access Permission Determination Process

A description will now be given below of a processing sequence in which access is limited by using the above-described access permission group database in communication via a network.

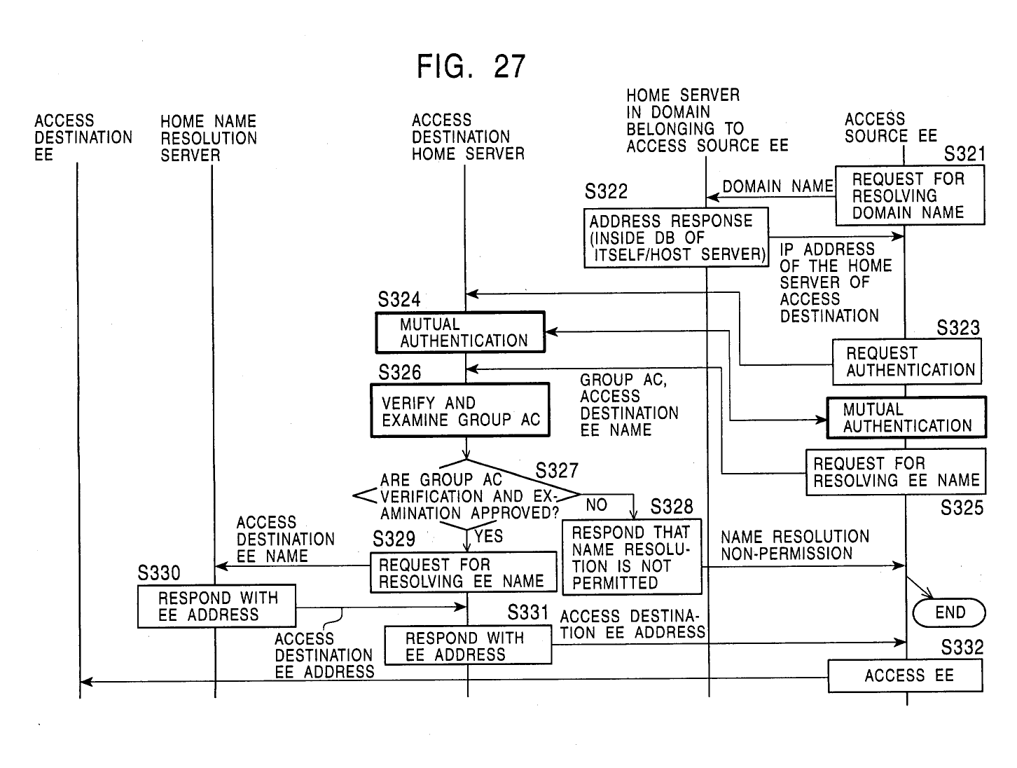

FIG. 27 shows a sequence when access to an access destination EE from an access source EE is performed via a network. In FIG. 27,

Access destination EE: an end entity (user device) as an access destination,

Home name resolution server: a server which performs an address obtaining process (name resolution process) from the host name concerning the access destination EE,

Access destination home server: a home server which determines name resolution based on the host name of the access destination EE in accordance with the attribute certificate presented from the access requesting source and the registered access permission information,

Home server in domain belonging to the access source EE: a home server, which is a management server for the access source EE, which functions as a relay server during communication via a network, and which performs a process for notifying the address of the access destination home server to the access destination EE, and

Access source EE: an end entity (user device) as a access source.

Initially, in step S321, the access source EE transmits the name of the domain to which the access source EE belongs, to the home server in the domain belonging to the access source EE. In step S322, the domain home server belonging to the access source EE notifies the IP address of the home server of the access destination, corresponding to the received domain name, to the access source EE by using the name resolution server in the management range thereof or managed by a higher-order server.

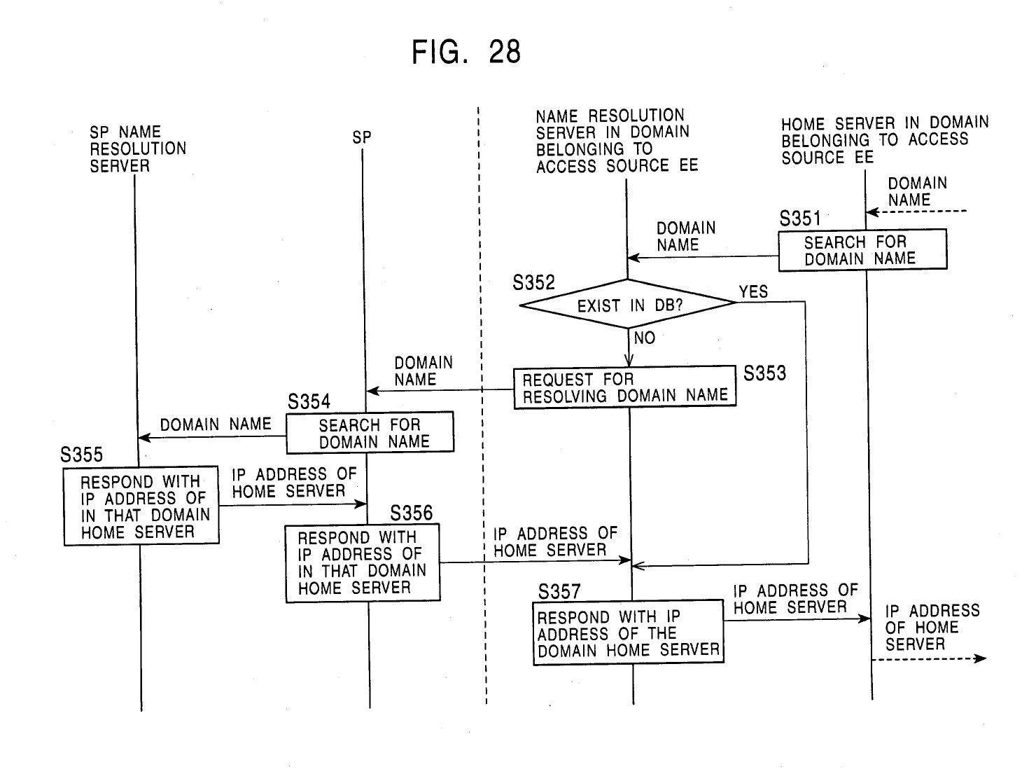

A description will now be given, with reference to FIG. 28, of a detailed process sequence for notifying the IP address of the access destination home server to the access source EE. In FIG. 28, an SP is the service provider (SP) of a higher-order domain of the domain server belonging to the access source EE, and an SP name resolution server is a name resolution server used by the SP.

When the home server in the domain belonging to the access source EE receives the domain name from the access source EE, in step S351, the name resolution server in the domain belonging to the access source EE requests the name resolution server in the domain belonging to the access source EE to obtain the address corresponding to the domain name.

The name resolution server in the domain belonging to the access source EE determines whether or not the domain is registered on the basis of the database described above with reference to, for example, FIG. 14. If the domain exists (Yes in step S352), the name resolution server obtains the address from the database, and in step S357, the name resolution server transmits the IP address of the home server corresponding to the domain name to the home server in the domain belonging to the access source EE, and the address information is transmitted from the home server in the domain belonging to the access source EE to the access requesting source EE.

On the other hand, if the domain is not registered in the database of the domain name resolution server belonging to the access source EE (No in step S352), the domain is transmitted to the service provider (SP) of the higher-order domain in order to request name resolution (S353). The service provider (SP) requests the SP name resolution server to search for the domain name (S354). The SP name resolution server obtains the IP address of the home server corresponding to the domain, and transmits the IP address to the service provider (SP) (S355). Then, the address information is transmitted from the service provider (SP) to the domain home server belonging to the access source EE (S356), and the address information is transmitted from the domain home server belonging to the access source EE to the access requesting source EE (S357).

While the example of FIG. 28 shows a case in which the address corresponding to the domain name is obtained by making an inquiry to one service provider (SP), repeated inquiries are made to the higher-order SP or the SP of another domain until the address is obtained, and necessary address information is obtained.

Referring back to FIG. 27, a description is continued below. In step S322, when the access source EE obtains the IP address of the access destination home server by the above-described processes, next, in step S323, the access source EE accesses the access destination home server in accordance with the received IP address of the home server of the access destination in order to perform mutual authentication (S324). The mutual authentication process is performed in accordance with the sequence described above with reference to, for example, FIG. 17. On condition that the mutual authentication is approved, the process proceeds to the subsequent step. In step S325, the access source EE sends its attribute certificate to the access destination home server, and makes a request for obtaining the address, that is, a name resolution process, from the host name of the access destination EE.

The access destination home server receiving the attribute certificate performs the verification and examination of the attribute certificate. The verification of the attribute certificate is a verification of the presence or absence of falsification by the signature verification. The examination is an examination of whether or not the group certified by the attribute certificate is registered as a permission group by referring to the above-described permission group database.

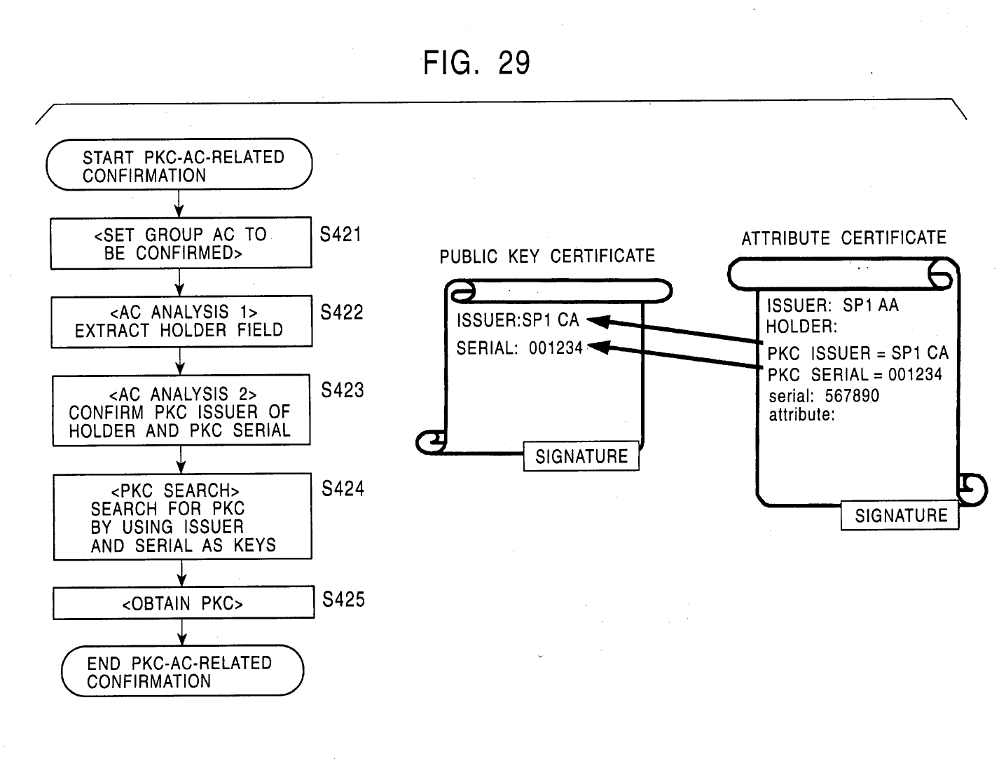

Details of the verification process of the attribute certificate will now be described with reference to FIGS. 29 to 31. Initially, the relation confirmation process between the attribute certificate (AC) and the public key certificate (PKC) is described with reference to FIG. 29. The flow of FIG. 29 shows a process of confirming the public key certificate (PKC) related to the attribute certificate (AC), which is performed when the verification of the attribute certificate (AC) is performed.

When the attribute certificate (AC) to be confirmed is set (S421), the public key certificate information (holder) field of the AC owner of the attribute certificate is extracted (S422). The issuer information (PKC issuer) of the public key certificate stored in the extracted public key certificate information (holder) field, and the public key certificate serial number (PKC serial) are confirmed (S423). The public key certificate (PKC) is searched for on the basis of the issuer information (PKC issuer) of the public key certificate and the public key certificate serial number (PKC serial) (S424). The public key certificate (PKC) associated with the attribute certificate (AC) is obtained (S425).

As shown in FIG. 29, the attribute certificate (AC) and the public key certificate (PKC) are associated with each other by the issuer information (PKC issuer) of the public key certificate in the public key certificate information (holder) field stored in the attribute certificate, and the public key certificate serial number (PKC serial).

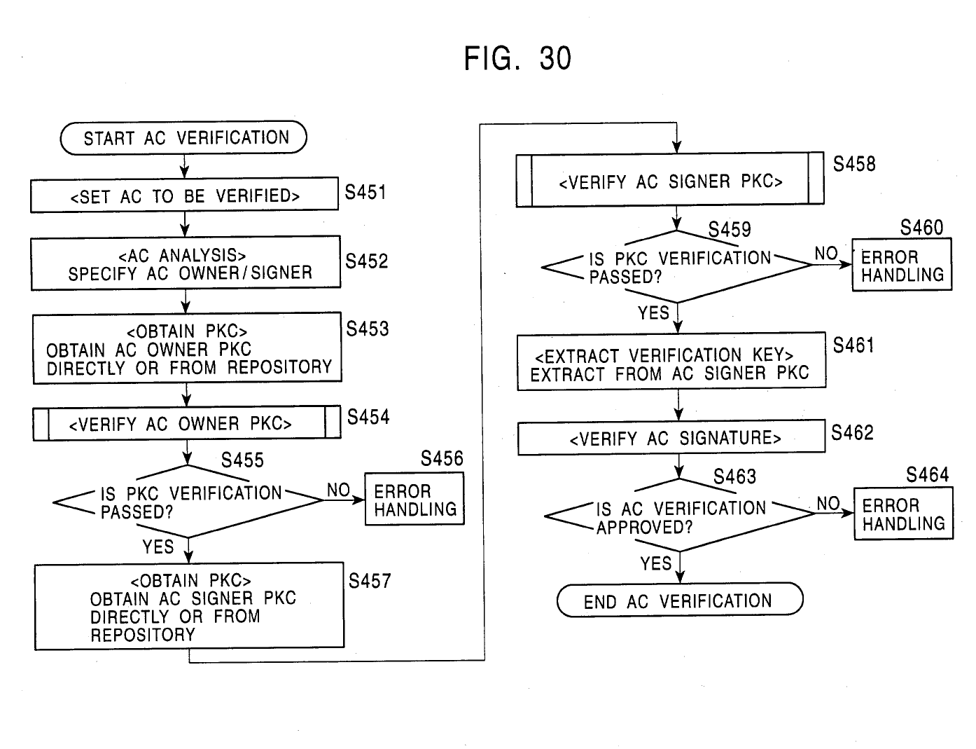

The process of verifying the attribute certificate (AC) will now be described with reference to FIG. 30. Initially, the attribute certificate (AC) to be verified is set (S451), and based on the stored information of the attribute certificate (AC), the owner and the signer of the attribute certificate (AC) are specified (S452). Furthermore, the public key certificate of the owner of the attribute certificate (AC) is obtained directly or from a repository, etc. (S453), and the process of verifying the public key certificate is performed (S454).

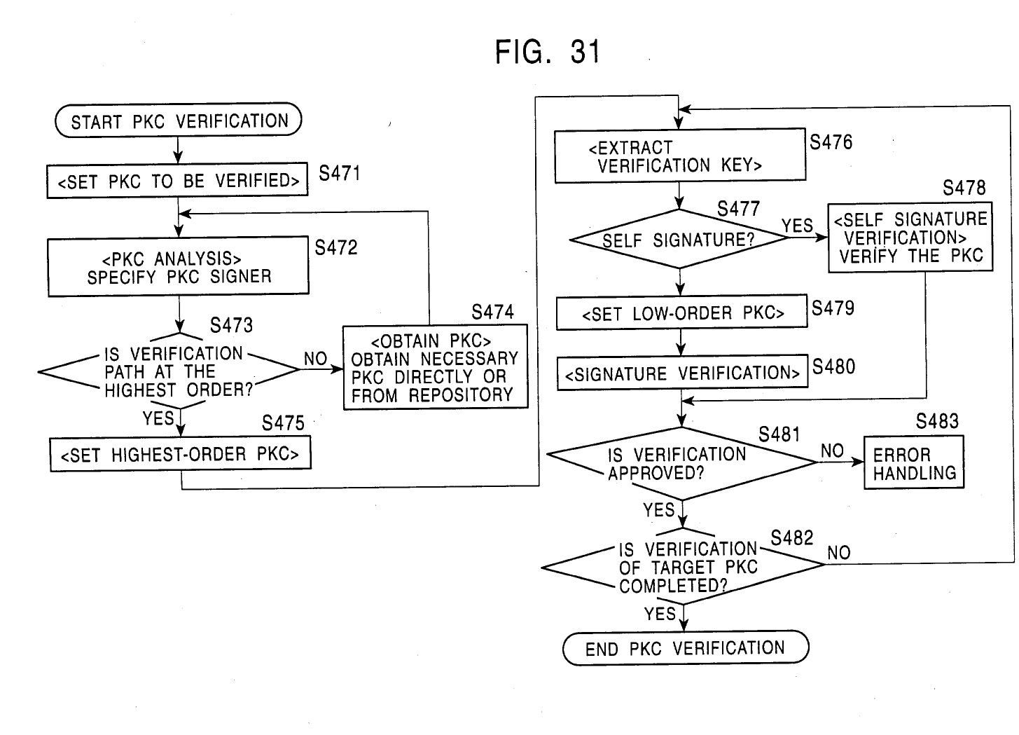

The process of verifying the public key certificate (PKC) will now be described with reference to FIG. 31. The verification of the public key certificate (PKC) shown in FIG. 31 is a chain verification process flow such that the certificate chain is traced back from the low order to the high order in order to obtain the chain information up to the highest-order public key certificate, and the signature verification of the public key certificates up to the highest order (root CA) is performed. Initially, a public key certificate (PKC) to be verified is set (S471), and based on the stored information of the public key certificate (PKC), the signer of the public key certificate (PKC) is specified (S472). Furthermore, it is determined whether or not the public key certificate is the highest-order public key certificate of the chain of certificates to be verified (S473). When the public key certificate is not at the highest order, the highest-order public key certificate is obtained directly or from a repository (S474). When the highest-order public key certificate is obtained and set (S475), a verification key (public key) required for signature verification is obtained (S476), and it is determined whether or not the signature to be verified is a self signature (S477). If the signature is not a self signature, a lower-order PKC is set (S479), and signature verification is performed on the basis of the verification key (public key) obtained from the higher-order public key certificate (S480). In the self signature determination in step S477, when the signature is a self signature, verification in which the public key of itself is a verification key is performed (S478), and the process proceeds to step S481.

When the signature verification is successful (Yes in step S481), it is determined whether or not the verification of the target PKC is completed (S482). When the verification is completed, the PKC verification is terminated. If the verification is not completed, the process returns to step S476, where obtaining the verification key (public key). required for the signature verification and the signature verification of the lower-order public key certificate are repeatedly performed. If the signature verification is unsuccessful (No in step S481), the process proceeds to step S483, where an error-handling process, for example, a process for stopping the subsequent procedures, is performed.

Referring back to FIG. 30, the description of the attribute certificate verification process is continued below. When the verification of the public key certificate, which is described in FIG. 31, fails (No in step S455), the process proceeds to step S456, where an error-handling process is performed, for example, subsequent processes are stopped. When the verification of the public key certificate is successful (Yes in step S455), the public key certificate corresponding to the signer of the attribute certificate (AC) is obtained directly or from the repository (S457), and the verification process for the public key certificate corresponding to the signer of the attribute certificate (AC) is performed (S458).

When the verification of the public key certificate corresponding to the signer of the attribute certificate (AC) is unsuccessful (No in step S459), the process proceeds to step S460, where an error-handling process is performed, for example, subsequent processes are stopped. When the verification of the public key certificate is successful (Yes in step S459), the public key is extracted from the public key certificate corresponding to the signer of the attribute certificate (AC) (S461), and a process of verifying the signature of the attribute certificate (AC) is performed using the extracted public key (S462). When the signature verification is unsuccessful (No in step S463), the process proceeds to step S464, where an error-handling process is performed, for example, subsequent processes are stopped. When the signature verification is successful (Yes in step S463), the verification of the attribute certificate is terminated, and subsequent processes are performed, that is, the group information registered as the attribute information of the attribute certificate is obtained, and a process of examining whether or not the obtained group information is registered as an access permission group in the permission group database is performed (see FIG. 25).

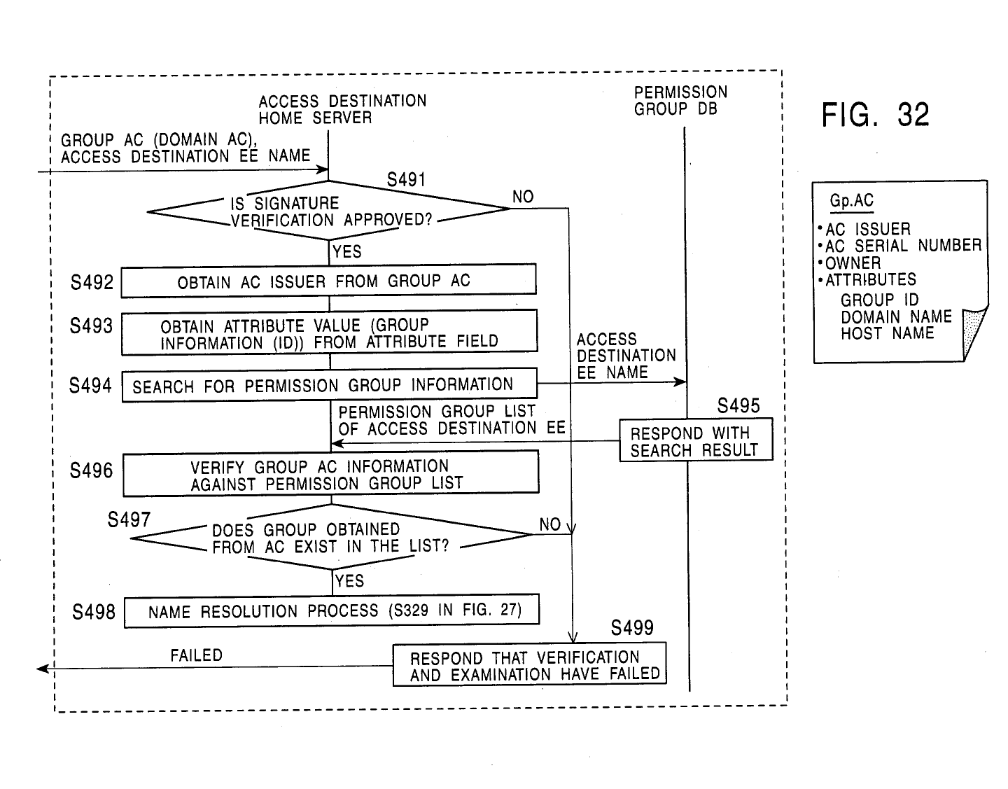

Details of the examination process will now be described with reference to FIG. 32. The determination of step S491 is a step of determining the verification result of the signature verification of the attribute certificate, described with reference to FIGS. 29 to 31. When the verification is unsuccessful, the process proceeds to step S499, where a response that the verification and examination are not approved is sent to the access source EE.

When the determination in step S491 is Yes, that is, when the signature verification of the attribute certificate is successful and when it is confirmed that the attribute certificate has not been falsified, in steps S492 and S493, the issuer information and the attribute information (group information) are obtained from the attribute certificate. This group information, as described above with reference to FIG. 6, is information of a group defined by various device groups, user groups, domains, hosts, etc., and is information formed of, for example, the group ID, the domain name, the host name, etc., as the group information.

In step S494, the access destination home server searches the permission group database (see FIG. 25) by using the access destination EE (host name) as a search key, and the permission group database responds with the permission group list of the access destination EE (host name) as a search result (S495). The home server determines whether or not the group information obtained from the group attribute certificate is contained in the received list (S497). When the group information is contained, in step S498, the home server requests the name resolution server to perform a name resolution process (S329 in FIG. 27). On the other hand, if the permission group information obtained from the group attribute certificate is not contained as the access group in the received list, the process proceeds to step S499, where a response that the verification and examination are not approved is sent to the access source EE.

Referring back to the sequence diagram in FIG. 27, a description is continued below. In step S326, after the verification of the group attribute certificate (Gp.AC), the group information registered as the attribute information of the attribute certificate is obtained. Then, a process of examining whether or not the obtained permission group information is registered as the access group in the permission group database is performed (see FIG. 25).

When the group attribute certificate is approved in the above-described verification and examination processes, that is, when the group attribute certificate is a valid certificate free from falsification and the group information recorded in the attribute information field of the attribute certificate is registered as the access permission group in the permission group database (see FIG. 25) (Yes in step S327), the process proceeds to step S329, where the access destination EE name (host name) is output to the home name resolution server. The home name resolution server has a database described above with reference to FIG. 14B, obtains the address corresponding to the access destination EE (host name) (S330), and responds to the access destination home server. In step S331, the access destination home server notifies the obtained address to the access source EE, and the access source EE performs access to the access destination EE on the basis of the obtained address.

On the other hand, when the determination of step S327 is No, that is, when the group attribute certificate is not approved in the verification and examination processes, that is, when it is not certified that the group attribute certificate is a valid certificate free from falsification, or when the group information recorded in the attribute information field of the attribute certificate is not registered as an access permission group in the permission group database (see FIG. 25), in step S328, a name resolution process is not performed, that is, a name resolution non-permission notification is transmitted to the access source EE. In this case, since the access source EE cannot obtain the address of the access destination EE, access cannot be performed.

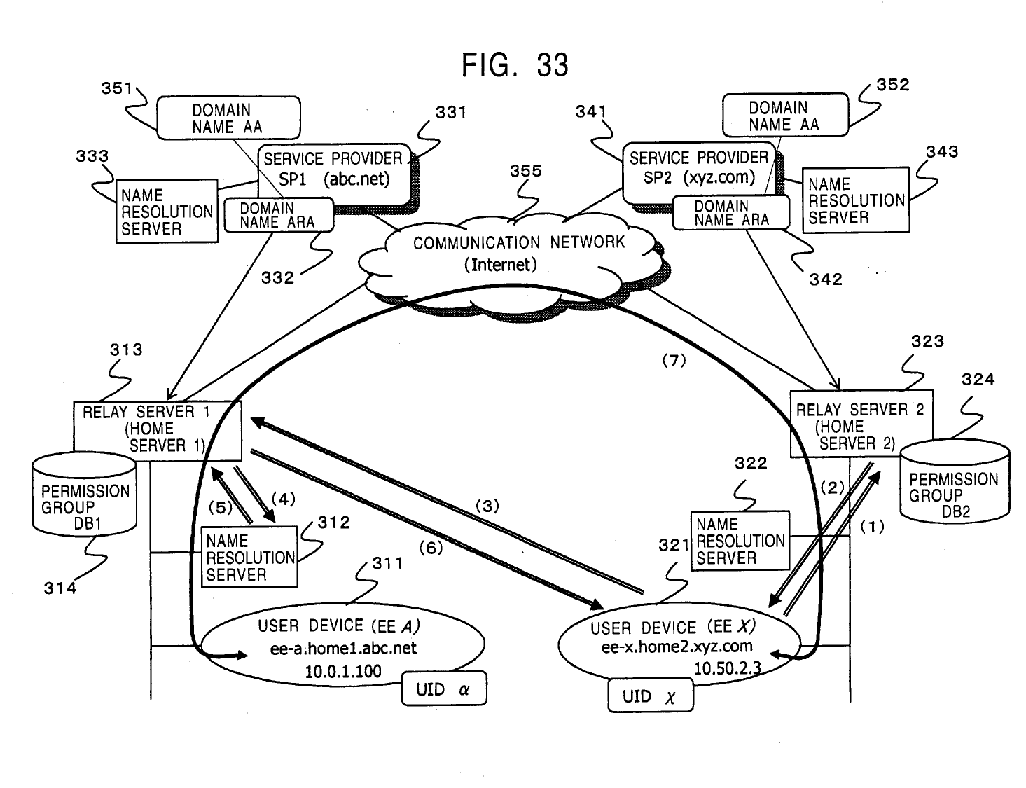

An overall description will now be given, with reference to FIG. 33, of a sequence performed in the access capability/incapability determination process based on the attribute certificate.

A user device 321 of FIG. 33 is an access source EE, a user device 311 is an access destination EE, and processing proceeds in the sequence from (1) to (7). Initially, in process (1), the user device (access source EE) 321 transmits the domain name of the access destination EE to a relay server 2 (home server 2) 323. The relay server 2 (home server 2) 323 obtains the address corresponding to the home server in the domain of the access destination EE, that is, the relay server 1 (home server 1) 313, via the name resolution server 322, a service provider 341 of a higher-order domain, or another server. In process (2), the relay server (2) 323 responds with the obtained address information to the user device (access source EE) 321.

The user device (access source EE) 321 accesses the relay server 1 (home server 1) 313 on the basis of the obtained address, sends the attribute certificate thereto, and makes a request for a name resolution process concerning the host name of the user device (access destination EE) 311. The relay server 1 (home server 1) 313 performs verification of the attribute certificate and examination based on the data of the permission group database 314. On condition that both the verification and examination are approved, in process (4), the relay server (home server 1) 313 performs the name resolution process for the host name of the user device (access destination EE) 311 by using the name resolution server 312. In process (5), the user device (access destination EE) 311 obtains the address corresponding to the host name of the user device (access destination EE) 311. In process (6), the user device (access destination EE) 311 notifies the obtained address to the user device (access source EE) 321.

Next, in process (7), the user device (access source EE) 321 accesses the user device (access destination EE) 311 on the basis of the obtained address.

In the manner described above, the fact that the access requesting source belongs to the access permission group which is set by the user device (end entity) of the access destination is confirmed becomes an access permission condition, and thus access from a large number of any general devices can be eliminated. Furthermore, since verification and examination based on the attribute certificate are performed, reliable examination becomes possible.

(3-5) Address Updating Process

The above-described technique makes it possible to limit access to a member of a group which is set by the access destination EE. If the address of the end entity (user device) is fixed, there is a possibility that access is made on the basis of the address information which is obtained once even after the member is excluded from the access permission group. In order to prevent such a situation, a process of changing the address dynamically will now be given.

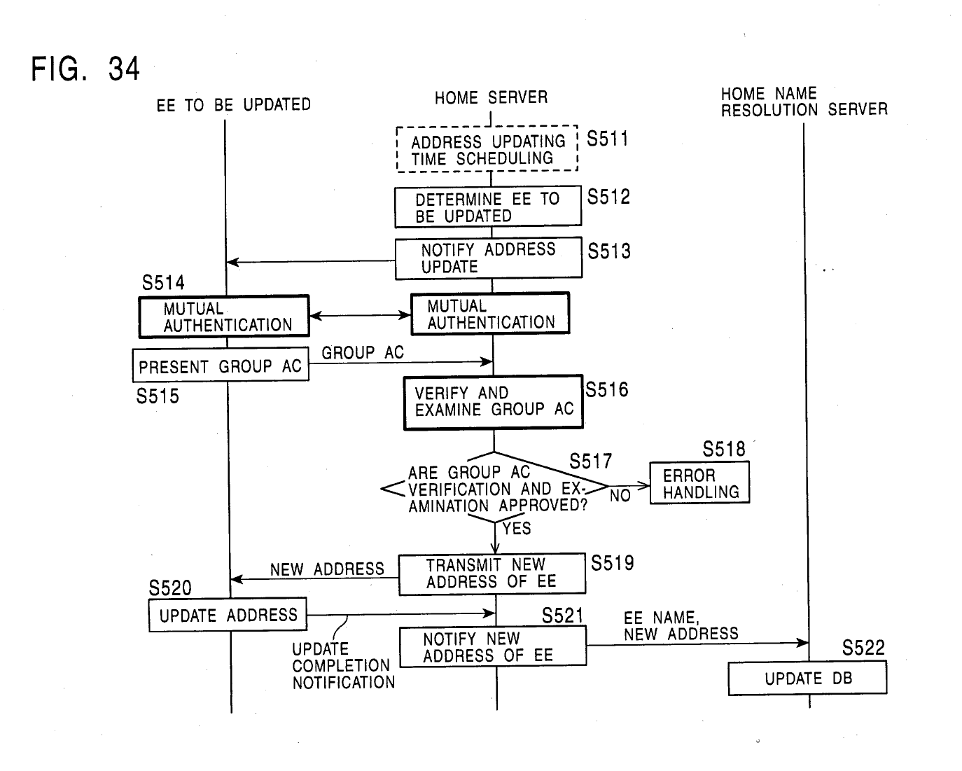

First, a description is given, with reference to the sequence diagram of FIG. 34, of a sequence in which the home server manages the address update schedule of the end entity and performs a process of updating the address of the end entity (EE) in accordance with the schedule. In FIG. 34,

EE to be updated: an end entity (user device) whose address is to be updated,

Home server: a home server which determines name resolution based on the host name of the EE to be updated in accordance with the attribute certificate presented from the access requesting source and the registered access permission information, and

Home name resolution server: a server which performs a process of obtaining the address (name resolution process) from the host name concerning the EE to be updated.

Initially, in step S511, the home server selects the end entity at an updating time in accordance with the address updating time schedule, and determines the EE to be updated (S512). The address updating time schedule data is formed such that, for example, the update execution schedule of a fixed period cycle for every predetermined days is management data for each end entity.

When the end entity to be updated is determined, in step S513, the address update notification is reported to the EE to be updated, and in step S514, mutual authentication between the home server and the EE to be updated is performed. The mutual authentication process is performed in accordance with the sequence described above with reference to, for example, FIG. 17. On condition that the mutual authentication is approved, the process proceeds to the subsequent step.

In step S515, the EE to be updated presents its own group attribute certificate to the home server. The group attribute certificate is, for example, a domain-name attribute certificate, a host-name attribute certificate, or a group attribute certificate in which other group information is stored as attribute information.

In step S516, the home server performs the verification and examination of the group attribute certificate (group AC) received from the EE to be updated. The verification and examination processes are processes compliant with the processes described above with reference to FIGS. 29 to 32. However, the examination here is not on whether or not access permission for the group corresponding to the permission group database is made, but on whether or not an entry corresponding to the EE to be updated exists in the permission group database. When the entry exists, the examination is approved.

When the verification and examination of the group AC are not approved (No in step S517), as an error handling process (S518), for example, an error message is sent to the EE to be updated. When the verification and examination of the group AC are approved (Yes in step S517), in step S519, the address of the EE to be updated is updated, and a new address is transmitted to the EE to be updated. In the EE to be updated, address update based on the new address is performed (S520), and the update completion notification is notified to the home server.

The home server notifies the new address of the EE to be updated, together with the name of the EE to be updated (host name), to the home name resolution server (S521), and the home name resolution server updates the name resolution database (see FIG. 14B) (S522).

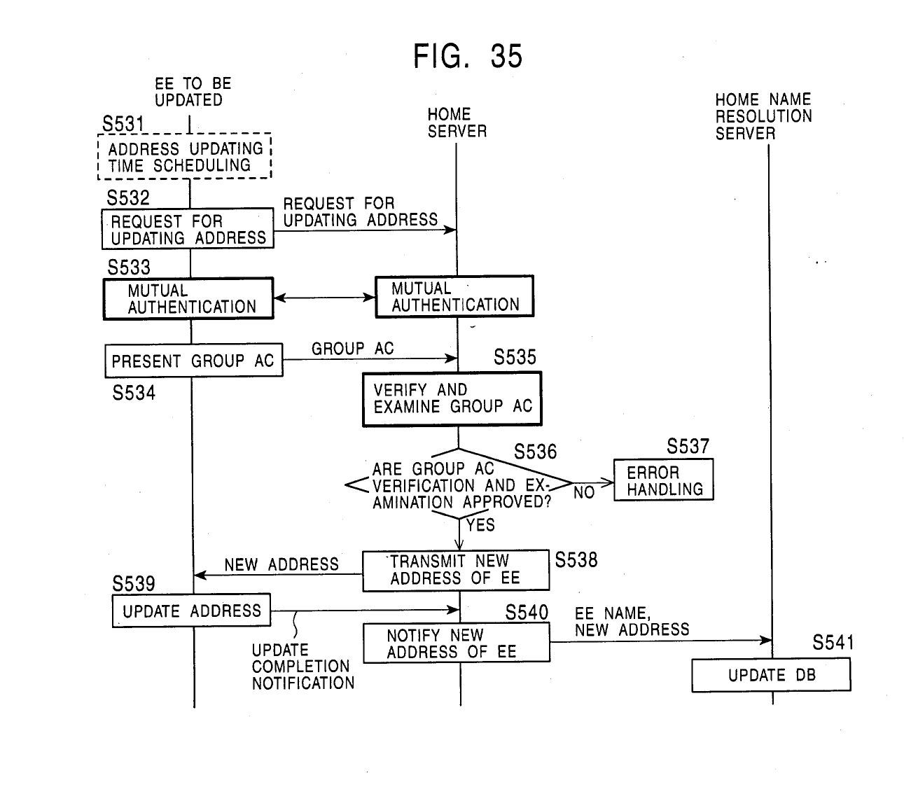

A description will now be given, with reference to the sequence diagram in FIG. 35, of a sequence in which the end entity (EE) itself to be updated manages its own address updating schedule, and performs an address updating process in accordance with the schedule. In FIG. 35,

EE to be updated: an end entity (user device) whose address is to be updated,

Home server: a home server which determines name resolution based on the host name of the EE to be updated in accordance with the attribute certificate presented from the access requesting source and the registered access permission information, and

Home name resolution server: a server which performs an address obtaining process (name resolution process) from the host name concerning the EE to be updated.

Initially, in step S531, the EE to be updated confirms the arrival of the updating time in accordance with the address updating time schedule. In step S532, the EE to be updated transmits an address update request to the home server, and in step S533, the EE to be updated performs mutual authentication between the home server and the EE to be updated. The mutual authentication process is performed in accordance with the sequence described above with reference to, for example, FIG. 17. On condition that the mutual authentication is approved, the process proceeds to the subsequent step.

In step S534, the EE to be updated presents its own group attribute certificate to the home server. The group attribute certificate is, for example, a domain-name attribute certificate, a host-name attribute certificate, or a group attribute certificate in which other permission group information is stored as attribute information.

In step S535, the home server performs the verification and examination of the group attribute certificate (group AC) received from the EE to be updated. The verification and examination processes are processes compliant with the processes described above with reference to FIGS. 29 to 32. However, the examination here is not on whether or not access permission for the group corresponding to the permission group database is made, but on whether or not an entry corresponding to the EE to be updated exists in the permission group database. When the entry exists, the examination is approved.

When the verification and examination of the group AC are not approved (No in step S536), as an error handling process (S537), for example, an error message is sent to the EE to be updated. When the verification and examination of the group AC are approved (Yes in step S536), in step S538, the address of the EE to be updated is updated, and a new address is transmitted to the EE to be updated. In the EE to be updated, address update based on the new address is performed (S539), and the update completion notification is reported to the home server.

The home server notifies the new address of the EE to be updated, together with the name of the EE to be updated (host name), to the home name resolution server (S540), and the home name resolution server updates the name resolution database (see FIG. 14B) (S541).

A description will now be given of a processing sequence in which the address corresponding to the domain name to which the home server and the end entity belong is updated.

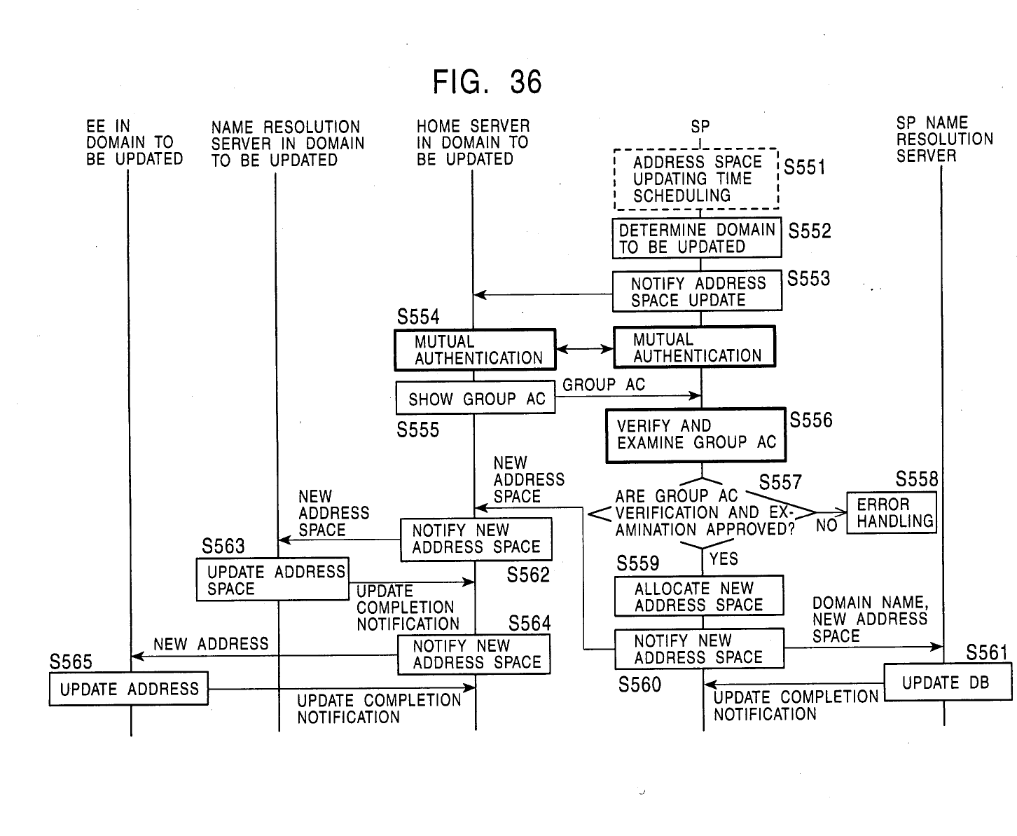

A description is given first, with reference to FIG. 36, of a sequence in which the service provider (SP) which manages the address corresponding to the domain name of the home server manages the address updating schedule, and performs a process of updating the address corresponding to the domain name to which the home server and the end entity belong in accordance with the schedule. In FIG. 36,

EE in domain to be updated: an end entity (user device) in a domain whose address corresponding to the domain name is to be updated,

Name resolution server in domain to be updated: a name resolution server in a domain whose address corresponding to the domain name is to be updated,

Home server in domain to be updated: a home server in a domain whose address corresponding to the domain name is to be updated,

SP: a service provider (SP) which manages the address corresponding to the domain name, and

SP name resolution server: a name resolution server, managed by an SP, having data (see FIG. 14A) for performing a process of obtaining the address corresponding to the domain name.

Initially, in step S551, the service provider (SP) selects a domain at an updating time and determines the domain to be updated in accordance with the address updating time schedule (S552). The address updating time schedule data is formed such that, for example, the update execution schedule of a fixed period cycle for every predetermined days is management data for each domain.

When the domain to be updated is determined, in step S553, the address space update notification is reported to the home server in the domain to be updated. In step S554, mutual authentication between the service provider (SP) and the home server in the domain to be updated is performed. The mutual authentication process is performed in accordance with the sequence described above with reference to, for example, FIG. 17. On condition that the mutual authentication is approved, the process proceeds to the subsequent step.

In step S555, the home server in the domain to be updated presents its own group attribute certificate to the service provider (SP). The group attribute certificate is, for example, a domain-name attribute certificate, or a group attribute certificate in which other group information is stored as attribute information.

In step S556, the service provider (SP) performs the verification and examination of the group attribute certificate (group AC) received from the home server in the domain to be updated. The verification and examination processes are processes compliant with the processes described above with reference to FIGS. 29 to 32. However, the examination here is not on whether or not access permission for the group corresponding to the permission group database is made, but on whether or not an entry corresponding to the home server in the domain to be updated exists in the permission group database. When the entry exists, the examination is approved.

When the verification and examination of the group AC are not approved (No in step S557), as an error handling process (S558), for example, an error message is sent to the home server in the domain to be updated. When the verification and examination of the group AC are approved (Yes in step S557), in step S559, the new address space corresponding to the domain to be updated is allocated.

Next, the service provider (SP) notifies the new address space corresponding to the domain to be updated to the home server in the domain to be updated, and further notifies the new address space data together with the domain name to the SP name resolution server (S560). The SP name resolution server updates the name resolution database (see FIG. 14A) (S561).

Furthermore, the home server in the domain to be updated reports the new address space notification to the name resolution server in the domain to be updated (S562), and the name resolution server in the domain to be updated updates the name resolution database (see FIG. 14B) (S563) and transmits the update completion notification to the home server in the domain to be updated. The home server in the domain to be updated further notifies the new updated address to the EE in the domain to be updated, which is its own management end entity (user device) (S564). In the EE in the domain to be updated, address update based on the new address is performed (S565), the update completion notification is reported to the home server in the domain to be updated, and the updating process is terminated.

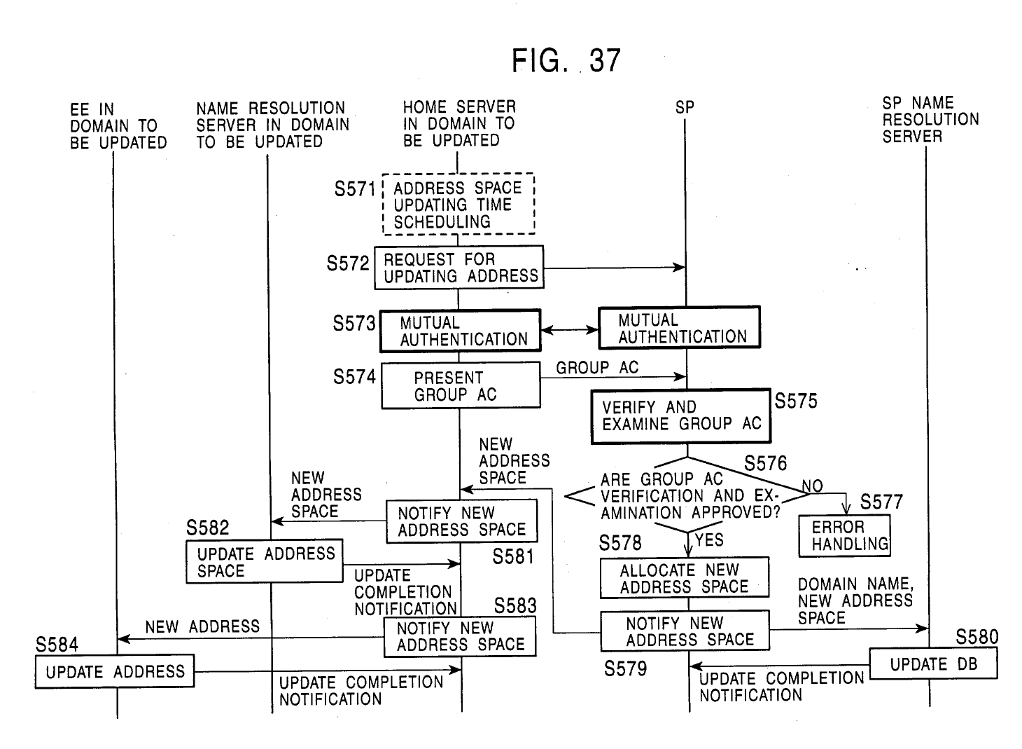

A description will now be given, with reference to FIG. 37, of a sequence in which the home server itself manages the address corresponding to the domain name, and performs a process of updating the address corresponding to the domain name to which the home server and the end entity belong in accordance with the schedule. In FIG. 37,

EE in domain to be updated: an end entity (user device) in a domain whose address corresponding to the domain name is to be updated,

Name resolution server in domain to be updated: a name resolution server in a domain whose address corresponding to the domain name is to be updated,

Home server in domain to be updated: a home server in a domain whose address corresponding to the domain name is to be updated,

SP: a service provider (SP) which manages the address corresponding to the domain name, and

SP name resolution server: a name resolution server, managed by the SP, having data (see FIG. 14A) for performing a process of obtaining the address corresponding to the domain name.

Initially, in step S571, when the home server in the domain to be updated confirms the arrival of the updating time in accordance with the address updating time schedule, the home server in the domain to be updated notifies an address update request to the service provider (SP) (S572). In step S573, mutual authentication between the service provider (SP) and the home server in the domain to be updated is performed. The mutual authentication process is performed in accordance with the sequence described above with reference to, for example, FIG. 17. On condition that the mutual authentication is approved, the process proceeds to the subsequent step.

In step S574, the home server in the domain to be updated presents its own group attribute certificate to the service provider (SP). The group attribute certificate is, for example, a domain-name attribute certificate, or a group attribute certificate in which other group information is stored as attribute information.

In step S575, the service provider (SP) performs the verification and examination of the group attribute certificate (group AC) received from the home server in the domain to be updated. The verification and examination processes are processes compliant with the processes described above with reference to FIGS. 29 to 32. However, the examination here is not on whether or not access permission for the group corresponding to the permission group database is made, but on whether or not an entry corresponding to the home server in the domain to be updated exists in the permission group database. When the entry exists, the examination is approved.

When the verification and examination of the group AC are not approved (No in step S576), as an error handling process (S577), for example, an error message is sent to the home server in the domain to be updated. When the verification and examination of the group AC are approved (Yes in step S576), in step S578, the new address space corresponding to the domain to be updated is allocated.

Next, the service provider (SP) notifies the new address space corresponding to the domain to be updated to the home server in the domain to be updated, and further notifies the new address space data together with the domain name to the SP name resolution server (S579). The SP name. resolution server updates the name resolution database (see FIG. 14A) (S580).

Furthermore, the home server in the domain to be updated reports the new address space notification to the name resolution server in the domain to be updated (S581), and the name resolution server in the domain to be updated updates the name resolution database (see FIG. 14B) (S582) and transmits the update completion notification to the home server in the domain to be updated. The home server in the domain to be updated further notifies the updated new address to the EE in the domain to be updated, which is its own management end entity (user device) (S583). In the EE in the domain to be updated, address update based on the new address is performed (S584), the update completion notification is reported to the home server in the domain to be updated, and the updating process is terminated.

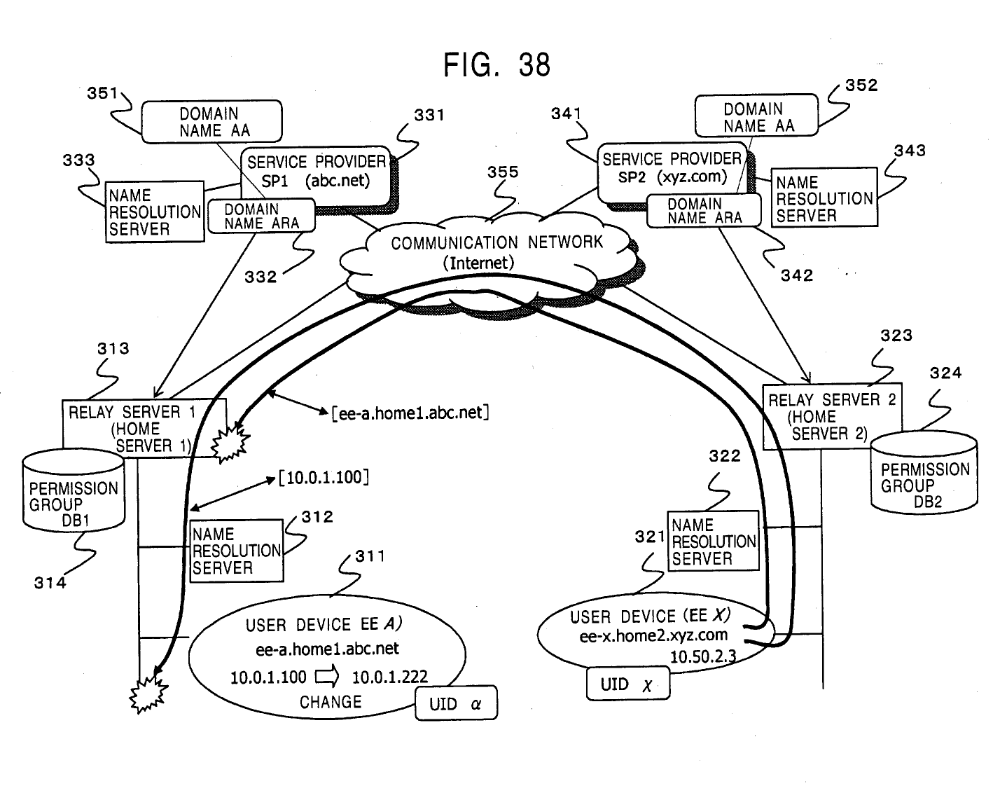

A description will now be given of advantages by address update with reference to FIG. 38. The user device 321 of FIG. 38 is an access source EE, and the user device 311 is an access destination EE. It is assumed that the user device (access source EE) 321 was recognized in the past by the user device (access destination EE) 311 as a member of the access permission group, but at present, the user device (access source EE) 321 is excluded from the members of the access permission group.

For example, it is assumed that the domain name home2.xyz.com of the user device (access source EE) 321 was registered as an access permission group in the permission group database 314 used by the relay server 1 (home server 1) 313 which manages the user device (access destination EE) 311, and thereafter, the domain name is deleted. Furthermore, it is assumed that the user device (access destination EE) 311 has performed address update in accordance with the above-described description, and has performed a process for updating the address from the old address 10.0.1.100 to the new address 10.0.1.222.

Even if the user device (access source EE) 321 tries to access the user device (access destination EE) 311 by using the address 10.0.1.100 obtained when access to the user device (access destination EE) 311 was made in the past, since the current address of the user device (access destination EE) 311 is a new address 10.0.1.222, access thereto cannot be made.

Furthermore, even if the new address is obtained by the name resolution process by using the host name eea.home1.abc.net of the user device (access destination EE) 311 in order to perform access, it is determined by the attribute certificate verification and examination in the relay server 1 (home server 1) 313 that the user device (access source EE) 321 is not recognized by the user device (access destination EE) 311 as a member of the access permission group. Thus, the name resolution process is rejected, the new address is not obtained, and the execution of the access in accordance with the new address is prevented.

(4) Configuration of Each Entity

A description will now be given, with reference to a figure, of an example of the configuration of an communication processing device of each entity, such as an end entity (EE) as a user device which performs the above-described processes, that is, the creation, the notification, the transmission and reception, etc., of the attribute certificate, a home server as a relay server, or a service provider (SP).

The communication processing device of each entity, such as a user device, a home server, or a service provider, has a CPU for performing various data processes and control, and may be formed of various communication processing devices, such as a server, a PC, a PDA, and a portable communication terminal device, having communication means capable of communicating with another entity.

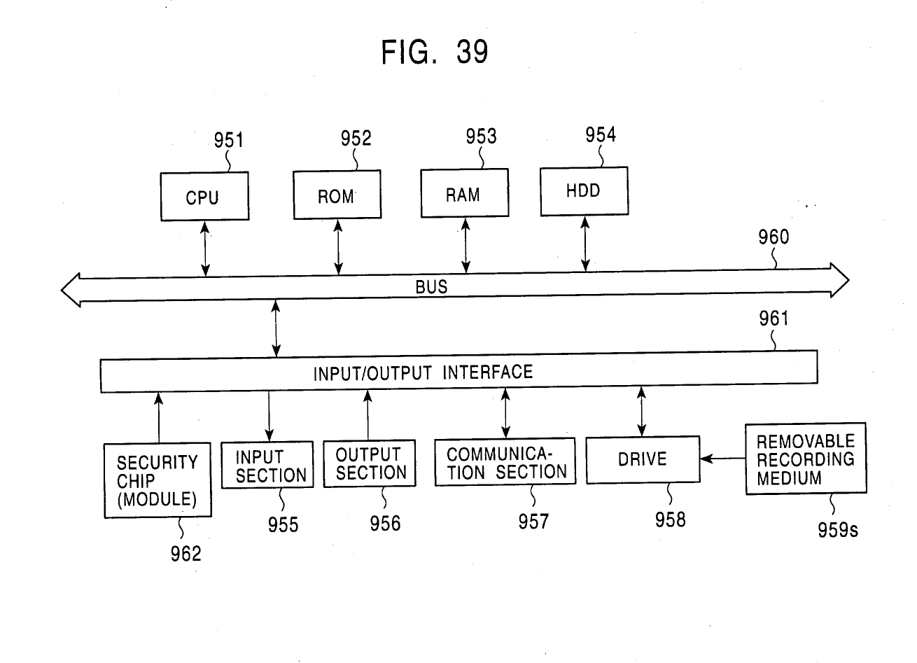

FIG. 39 shows an example of the configuration of a communication processing device. The example of the configuration shown in FIG. 39 is one example, and each entity is not necessarily required to comprise all these functions shown here. A CPU (Central Processing Unit) 951 shown in FIG. 39 is a processor for executing various application programs and the OS (Operating System). A ROM (Read Only Memory) 952 stores programs executed by the CPU 951, and fixed data as computation parameters. A RAM (Random Access Memory) 953 is used as an area for storing parameters which vary as appropriate in program processes, and as a work area.

A hard disk drive (HDD) 954 executes control of a hard disk, and performs processes for storing and reading various types of data and programs into and from the hard disk. A security chip 962 is tamper-resistant in the manner described above, stores key data required for an encryption process, and has an encryption processing section for performing a process for verifying and creating the attribute certificate in an authorization confirmation process, a data processing section, and a memory.

A bus 960 is formed of a PCI (Peripheral Component Interface) bus, etc., allowing transfer of data with each module and each input device via an input/output interface 961.

An input section 955 includes, for example, a keyboard and a pointing device, and is operated by a user in order to input various commands and data to the CPU 951. An output section 956 includes, for example, a CRT and a liquid-crystal display, and displays various types of information in the form of text or images.

A communication section 957 is formed of a network interface and a connected-device interface for performing a communication process with an entity to which a device is connected, for example, a service provider. The communication section 957 performs processes for transmitting data supplied from each storage section, data processed by the CPU 951, encrypted data, etc., or for receiving data from another entity under the control of the CPU 951.

A drive 958 is a drive for performing recording and playback to and from a removable recording medium 959, such as a flexible disk, a CD-ROM (Compact Disc Read Only Memory), an MO (Magneto-optical) disk, a DVD (Digital Versatile Disc), a magnetic disk, or a semiconductor memory. The drive 958 plays back a program or data from each removable recording medium 959 or stores a program or data in the removable recording medium 959.

When the program or the data recorded on each recording medium is read and the CPU 951 executes the program or performs a process on the data, the read program or data is supplied to, for example, the RAM 953 connected via the interface 961 and the bus 960.

The program for executing a process in a user device, a service provider, etc., included in the foregoing description is stored in, for example, the ROM 952, and is processed by the CPU 951, or is stored in the hard disk and is supplied via the HDD 954 to the CPU 951, whereby the program is executed.

In the foregoing, the present invention has been described in detail while referring to the specific embodiments. However, it is self-explanatory that a person skilled in the art can modify or substitute the embodiments without departing from the spirit and the scope of the invention. That is, the present invention has been disclosed in the form of examples, and should not be construed as being limited thereto. In order to determine the gist of the present invention, the claim section should be taken into consideration.

A series of processes described in the specification can be performed by hardware, software, or a combined configuration of them. In a case where the series of processes is performed by software, a program in which a processing sequence is recorded can be installed into a memory in a computer incorporated into dedicated hardware, whereby the program can be executed, or into a general-purpose computer capable of executing various types of processes, whereby the program can be executed.

For example, the program may be recorded in advance in a hard disk or a ROM (Read Only Memory) as a recording medium. Alternatively, the program may be temporarily or permanently stored (recorded) in a removable recording medium such as a flexible disk, a CD-ROM (Compact Disc Read Only Memory), an MO (Magneto-optical) disk, a DVD (Digital Versatile Disk), a magnetic disk, or a semiconductor memory. Such a removable recording medium can be provided as commonly called packaged software.

In addition to being installed into a computer from the above-described removable recording medium, programs may be transferred wirelessly from a download site to a computer or may be transferred by wire to a computer via a network, such as a LAN (Local Area Network) or the Internet, and in the computer, the programs which are transferred in such a manner can be received and installed into a recording medium such as the hard disk contained therein.

Various processes described in the specification may be executed chronologically according to the written orders. However, they do not have to be executed chronologically, and they may be executed concurrently or individually according to the processing performance of the device which performs a process or according to the necessity. The system in this specification is a logical assembly of a plurality of devices, and is not limited to a configuration in which each device is in the same housing.

What is claimed is:

1. An access authorization management system in communication among communication processing devices via a communication network, said access authorization management system comprising:
a name resolution server, having correspondence data between host names and addresses of access-destination communication processing devices, for performing a name resolution process concerning a host name corresponding to an access-destination communication processing device; and
a relay server which receives the host name of the access-destination communication processing device from an access-source communication processing device, which receives a group attribute certificate storing group identification information which is set so as to correspond to a group formed of a set of specific communication processing devices and having an issuer electronic signature, which performs a process of verifying the group attribute certificate and a process of examining whether or not the access-source communication processing device belongs to the access permission group of the access-destination communication processing device, which obtains the address of the access-destination communication processing device by a name resolution process using said name resolution server on condition that the verification and examination are successful, and which notifies the address to said access-source communication processing device.

2. An access authorization management system according to claim 1, wherein said group attribute certificate stores a domain name as group identification information, and
said relay server performs a process of examining whether or not the access-source communication processing device belongs to the access permission group of the access-destination communication processing device by referring to a permission group database storing access permission group information by domain name as the access permission group information for said access-destination communication processing device.

3. An access authorization management system according to claim 1, wherein said group attribute certificate stores a host name as group identification information, and
said relay server performs a process of examining whether or not the access-source communication processing device belongs to the access permission group of the access-destination communication processing device by referring to a permission group database which stores access permission group information by host name as the access permission group information for said access-destination communication processing device.

4. An access authorization management system according to claim 1, wherein said relay server is a home server connected via a network to said access-destination communication processing device.

5. An access authorization management system according to claim 1, wherein said relay server has a configuration for performing an updating process for the address corresponding to the domain name or the host name corresponding to said access-destination communication processing device, and performs said updating process on condition that the verification of an attribute certificate possessed by said access-destination communication processing device is approved.

6. An access authorization management system according to claim 1, wherein said relay server performs mutual authentication with the access-source communication processing device and performs the verification and examination of the group attribute certificate presented from said access-source communication processing device on condition that the mutual authentication is approved.

7. An access authorization management system according to claim 1, wherein said group attribute certificate stores link information on a public key certificate corresponding to the group attribute certificate, and
said relay server also performs verification of the public key certificate obtained by said link information when verifying said group attribute certificate.

8. A relay server for performing access authorization management in communication among communication processing devices via a communication network,
wherein said relay server receives a host name of an access-destination communication processing device from an access-source communication processing device, receives a group attribute certificate storing group identification information which is set so as to correspond to a group formed of a set of specific communication processing devices and having an issuer electronic signature, performs a process of verifying the group attribute certificate and a process of examining whether or not the access-source communication processing device belongs to the access permission group of the access-destination communication processing device, obtains the address of the access-destination communication processing device by the name resolution process using a name resolution server on condition that the verification and examination are successful, and notifies the address to said access-source communication processing device.

9. A relay server according to claim 8, wherein said group attribute certificate stores a domain name as group identification information, and
said relay server performs a process of examining whether or not the access-source communication processing device belongs to the access permission group of the access-destination communication processing device by referring to the permission group database in which access permission group information using domain names is stored as the access permission group information for said access-destination communication processing device.

10. A relay server according to claim 8, wherein said group attribute certificate stores a host name as group identification information, and
said relay server performs a process of examining whether or not the access-source communication processing device belongs to the access permission group of the access-destination communication processing device by referring to a permission group database in which access permission group information using host names is stored as the access permission group information for said access-destination communication processing device.

11. A relay server according to claim 8, wherein said relay server is a home server connected via a network to said access-destination communication processing device.

12. A relay server according to claim 8, wherein said relay server has a configuration for performing a process for updating an address corresponding to the domain name or the host name corresponding to said access-destination communication processing device, and performs said updating process on condition that the verification of an attribute certificate possessed by said access-destination communication processing device is approved.

13. A relay server according to claim 8, wherein said relay server performs mutual authentication with the access-source communication processing device, and performs the verification and examination of a group attribute certificate presented from said access-source communication processing device.

14. A relay server according to claim 8, wherein said group attribute certificate stores link information on a public key certificate corresponding to the group attribute certificate, and
said relay server also performs the verification of the public key certificate obtained by said link information when verifying said group attribute certificate.

15. An access authorization management method in communication among communication processing devices via a communication network, said access authorization management method comprising the steps of:
receiving, in a relay server, the host name of an access-destination communication processing device from an access-source communication processing device, and receiving a group attribute certificate storing group identification information which is set so as to correspond to a group formed of a set of specific communication processing devices and having an issuer electronic signature;
performing a process of verifying the group attribute certificate and a process of examining whether or not the access-source communication processing device belongs to the access permission group of the access-destination communication processing device; and
obtaining the address of the access-destination communication processing device by a name resolution process using a name resolution server on condition that the verification and examination are approved and notifying the address to said access-source communication processing device.

16. An access authorization management method according to claim 15, wherein said group attribute certificate stores a domain name as group identification information, and
said relay server performs a process of examining whether or not the access-source communication processing device belongs to the access permission group of the access-destination communication processing device by referring to a permission group database in which access permission group information using domain names is stored as the access permission group information for said access-destination communication processing device.

17. An access authorization management method according to claim 15, wherein said group attribute certificate stores a host name as group identification information, and
said relay server performs a process of examining whether or not the access-source communication processing device belongs to the access permission group of the access-destination communication processing device by referring to a permission group database in which access permission group information using host names is stored as the access permission group information for said access-destination communication processing device.

18. An access authorization management method according to claim 15, wherein said relay server is a home server connected via a network to said access-destination communication processing device.

19. An access authorization management method according to claim 15, further comprising a step in which said relay server performs a process of updating the address corresponding to the domain name or the host name corresponding to said access-destination communication processing device,
wherein said updating process is performed on condition that the verification of the attribute certificate possessed by said access-destination communication processing device is approved.

20. An access authorization management method according to claim 15, wherein said relay server performs mutual authentication with the access-source communication processing device, and performs the verification and examination of the group attribute certificate presented from said access-source communication processing device on condition that the mutual authentication is approved.

21. An access authorization management method according to claim 15, wherein said group attribute certificate stores link information on the public key certificate corresponding to the group attribute certificate, and
said relay server also performs the verification of the public key certificate obtained by said link information when verifying said group attribute certificate.

22. A computer program for executing an access authorization management process in communication among communication processing devices via a communication network, said computer program comprising the steps of:
receiving the host name of an access-destination communication processing device from an access-source communication processing device, and receiving a group attribute certificate storing group identification information which is set so as to correspond to a group formed of a set of specific communication processing devices and having an issuer electronic signature;
performing a process of verifying the group attribute certificate and a process of examining whether or not the access-source communication processing device belongs to the access permission group of the access-destination communication processing device; and
obtaining the address of the access-destination communication processing device by a name resolution process using a name resolution server on condition that the verification and examination are approved, and notifying the address to said access-source communication processing device.
